(19) United States
(12) Patent Application Publication
(10) Pub. No.: US 2026/0288851 A1
(43) Pub. Date: Sep. 24, 2026

(54) SYSTEM

(71) Applicant: SoftBank Group Corp., Tokyo (JP)

(72) Inventor: Takahiro KOBAYASHI, Tokyo (JP)

(73) Assignee: SoftBank Group Corp., Tokyo (JP)

(21) Appl. No.: 19/567,031

(22) Filed: Mar. 14, 2026

(30) Foreign Application Priority Data
Mar. 19, 2025 (JP) 2025-045012

(51) Int. Cl. G06F 16/432; G06F 16/435; G06F 16/45; G06F 40/166; G06F 40/40; G06T 7/00; G06T 11/60; G10L 13/027; G10L 13/033; G10L 25/60

(52) U.S. Cl. CPC G06F 16/433; G06F 16/434; G06F 16/437; G06F 16/45; G06F 40/166; G06F 40/40; G06T 7/0002; G06T 11/60; G10L 13/027; G10L 13/033; G10L 25/60; G06T 2207/20084; G06T 2207/30168

(57) ABSTRACT

A system includes a processor that is configured to receive, as an input, attribute information specified by a user, and generate a prompt for instructing a generative AI model to generate a virtual character based on the attribute information, generate, in accordance with a selection made by the user, a prompt for instructing a voice generation AI to generate a voice, analyze text and emojis received in a chat-based interaction, analyze an emotion of the user by using natural language processing based on the text and the emojis, generate a prompt for instructing a generative AI model to generate a comforting message based on a result of the analysis of the emotion, and present the generated comforting message to the user.

### CROSS-REFERENCE TO RELATED APPLICATION

This application is based on and claims priority under 35 USC 119 from Japanese Patent Application No. 2025-045012 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional systems that employ generative AI technologies for character creation, voice generation, and chat-based interaction are typically designed as separate or loosely coupled functions, and therefore cannot provide a consistent, emotionally supportive experience tailored to an individual user. In many cases, a user manually operates image generation tools to design a virtual character, separately configures or records voice, and then uses an independent chat system that does not take into account the user's emotional state in a unified manner. As a result, it is difficult to offer an integrated system in which a virtual character with user-defined attributes, a character voice matched to user preferences, and chat responses that provide a sense of reassurance are generated and controlled coherently. Furthermore, existing chat systems often respond in a generic way without sufficiently analyzing a user's emotions from both text and emojis, and therefore cannot dynamically generate appropriate comforting messages through a generative AI model. Accordingly, there is a need for a system that centrally manages attribute information specified by the user, voice selection made by the user, and chat interaction context, and that uses prompts to coordinate multiple AI models so as to generate and present to the user a virtual character and emotionally supportive responses in an integrated manner.

### SUMMARY

In order to solve the above-described problems, according to an aspect of the present invention, there is provided a system comprising a processor, wherein the processor is configured to receive, as an input, attribute information specified by a user, and generate a prompt for instructing a generative AI model to generate a virtual character based on the attribute information. The processor is further configured to generate, in accordance with a selection made by the user, a prompt for instructing a voice generation AI to generate a voice, thereby enabling a character voice that matches the user's preference to be generated. In addition, the processor is configured to analyze text and emojis received in a chat-based interaction, analyze an emotion of the user by using natural language processing based on the text and the emojis, generate a prompt for instructing a generative AI model to generate a comforting message based on a result of the analysis of the emotion, and present the generated comforting message to the user. In some embodiments, the processor is configured to generate, based on the attribute information of the user, a prompt for instructing an image generation AI to generate the virtual character, and generate the virtual character by using the image generation AI. In other embodiments, the processor is configured to generate, based on the selection made by the user, a prompt for instructing the voice generation AI to generate the voice, and generate the voice by using the voice generation AI. Through these configurations, the system can integrally control multiple AI models via prompts and can provide to the user a virtual character and chat responses that are both personalized and emotionally supportive.

The term “system” refers to an integrated arrangement of hardware, software, and network components configured to execute the processing operations described in the claims, including receiving user inputs, generating prompts, invoking AI models, and presenting outputs to a user.

The term “processor” refers to one or more hardware processing units, such as a CPU, GPU, or specialized accelerator, and associated control logic that execute instructions to perform the functions recited in the claims, including prompt generation, analysis of user inputs, and control of AI models.

The term “user” refers to a human operator who interacts with the system by providing inputs such as attribute information, selections related to voice generation, and chat messages including text and emojis, and who receives outputs such as virtual character images, generated voices, and comforting messages.

The term “attribute information” refers to information specified by the user that characterizes a virtual character, including but not limited to appearance attributes, personality attributes, and other properties used as a basis for generating the virtual character.

The term “prompt” refers to data generated by the processor that is supplied to a generative AI model, an image generation AI, or a voice generation AI, and that describes a desired output or instructs the AI to perform a specific generation task, such as generating a virtual character, generating a voice, or generating a comforting message.

The term “generative AI model” refers to an artificial intelligence model configured to generate content, such as text or images, in response to a prompt, and includes, for example, large language models and multimodal generative models used to generate virtual characters or comforting messages.

The term “virtual character” refers to a computer-generated character, including but not limited to a graphical or image-based representation, that is generated based on the attribute information specified by the user and is used as an entity for interaction within the system.

The term “image generation AI” refers to an artificial intelligence model configured to generate image data of the virtual character based on a prompt that encodes attribute information or other parameters relating to the appearance of the virtual character.

The term “voice generation AI” refers to an artificial intelligence model configured to generate audio data representing a voice, based on a prompt or configuration information that includes user selections such as pitch, speed, or accent, and text to be spoken.

The term “voice” refers to audio data generated by the voice generation AI, representing spoken content associated with the virtual character, and including properties such as pitch, speed, timbre, and accent.

The term “chat-based interaction” refers to an interaction mode in which the user and the system exchange messages primarily in the form of text and emojis, through an interface that presents a conversational history.

The term “text” refers to character-based input provided by the user in the chat-based interaction, including sentences, phrases, or other natural language expressions that the system analyzes for content and emotional meaning.

The term “emoji” refers to graphical symbols or pictograms included in the user's chat input, which represent emotional states, reactions, or other contextual information and are used together with text to infer the user's emotion.

The term “natural language processing” refers to a set of computational techniques and models used by the processor to analyze and interpret human language contained in the text and emojis, in order to extract information such as the user's emotional state.

The term “emotion of the user” refers to an affective state, such as sadness, happiness, confusion, anger, or other emotions, inferred by the system from the user's text and emojis using natural language processing and related analysis techniques.

The term “comforting message” refers to a message generated by a generative AI model in response to a prompt, the content of which is designed to provide reassurance, empathy, encouragement, or emotional support to the user based on the analyzed emotion.

The term “present the generated comforting message to the user” refers to causing the comforting message, in textual form, audio form, or a combination thereof, to be output to a user interface accessible to the user so that the user can perceive the message.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### FIRST EXEMPLARY EMBODIMENT

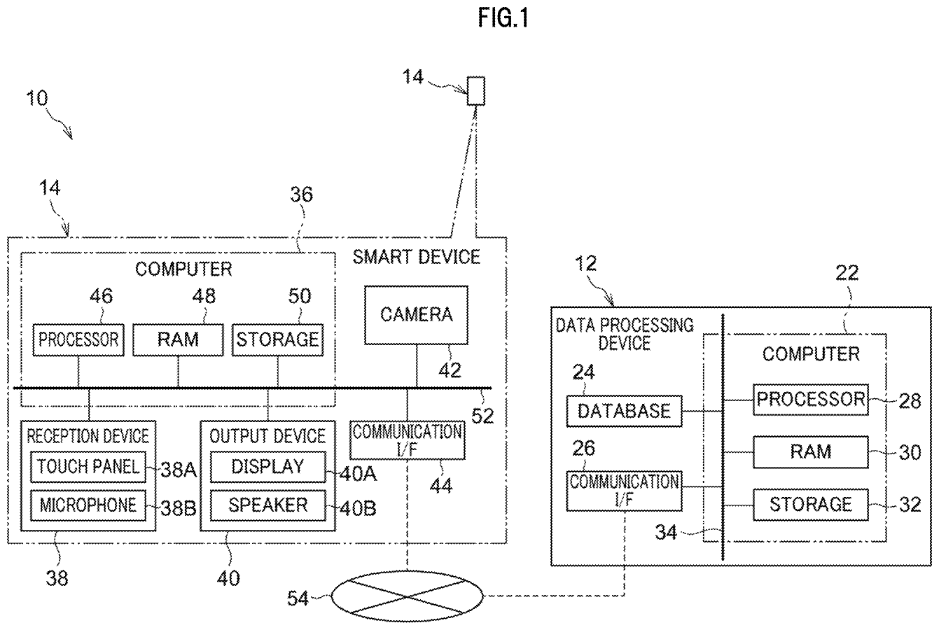

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

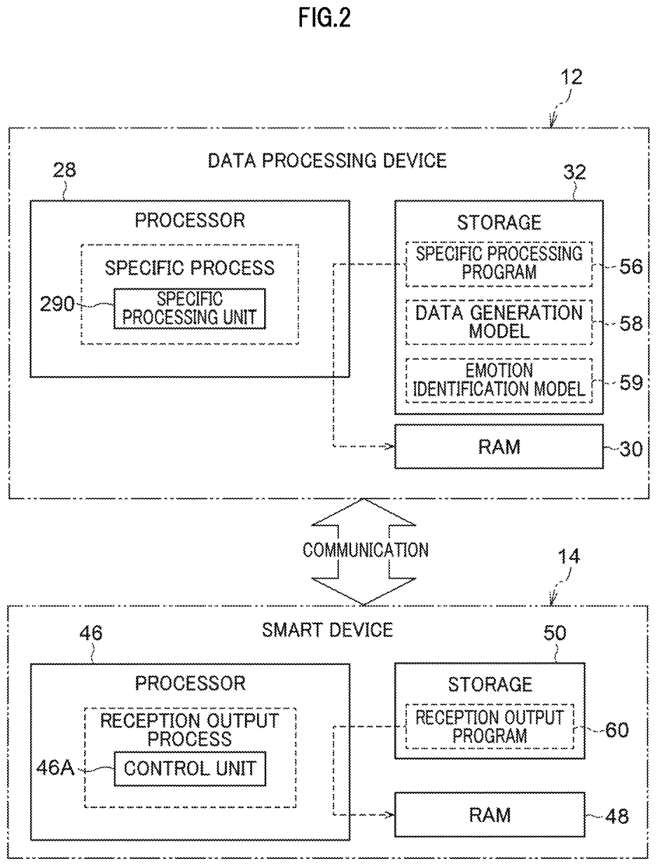

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional character generation systems using machine learning models typically treat visual generation, voice generation, and user emotion handling as separate and loosely coupled functions. In such systems, a client application must manually construct ad-hoc textual instructions for each model, manage different input formats for each model, and orchestrate separate calls to image generation, voice generation, and natural language generation components. As a result, the overall processing pipeline is fragmented, error-prone, and difficult to scale or optimize.

In particular, when a user specifies fine-grained character attributes, such as multiple physical features, decorative features, and expression styles, conventional systems often construct simplistic or incomplete text prompts, which are not well aligned with the internal representation expected by the generative models. This mismatch leads to unstable or inaccurate outputs, requiring multiple iterations and manual trial-and-error by the user, thereby increasing computational cost and degrading system responsiveness.

Furthermore, conventional systems generally do not integrate real-time emotion analysis of text and symbol inputs (such as emojis) into the core generation pipeline. Even when emotion analysis is available, it is usually implemented as an overlay that does not structurally modify the control flow or prompt construction for the underlying models. Consequently, the system cannot automatically adapt the content or style of generated visual representations, voice outputs, or messages according to the user's emotional state in a consistent, model-aware manner. Additionally, conventional architectures often perform only minimal or no standardized post-processing on generated images and audio, leaving tasks such as resizing, re-encoding, and storage management to disparate components or client devices. This causes redundant computations, inconsistent quality control, and inefficient network usage, as large, non-optimized media files are repeatedly transferred between servers and clients. Accordingly, there is a need for a computer-implemented system that improves the way generative AI models are orchestrated, by centrally managing (i) the transformation of structured user feature information into coherent prompt sentences, (ii) the selection and invocation of appropriate generative AI models, (iii) the integration of emotion analysis results into prompt generation and regeneration control, and (iv) the standardized post-processing, encoding, and delivery of generated media. Such a system should reduce the complexity and overhead of client-side orchestration, improve consistency and quality of generated outputs, and enhance the scalability and efficiency of the underlying computing infrastructure.

The specific processing by the specific processing unit 290 of the data processing device 12 in Example 1 is realized by the following means.

The present invention provides a server comprising a processor configured to receive, from a user via a terminal, attribute information and other feature information of a virtual character, convert the feature information into internal structured data, and automatically generate one or more prompt sentences in a natural language based on the structured data; to select, based on the structured data and optional style information, at least one generative AI model from among an image generative AI model and a voice generative AI model, to normalize and preprocess each generated prompt sentence into a model-specific input format, and to cause the selected generative AI model to generate at least one of a visual representation or a voice representation corresponding to the virtual character; to analyze character information and symbol information received from the user in a chat format by using a natural language processing module and an emotion classification module, to estimate an emotional state of the user, and to automatically construct a response prompt sentence that includes content for providing reassurance or support to the user in accordance with the estimated emotional state, and to cause a generative AI model to generate a message based on the response prompt sentence; to perform standardized post-processing on image data output from the image generative AI model, including adjusting at least one of image size, shape, quality, and background, encoding the adjusted image into a predetermined media format, storing the adjusted image in a storage device, and transmitting reference information of the stored image to the terminal; to generate a voice generation prompt sentence including text information and speaker style information, to cause the voice generative AI model to generate voice data corresponding to the voice generation prompt sentence, to encode the voice data into a predetermined audio format, store the encoded voice data or its reference in the storage device, and transmit the encoded voice data or the reference to the terminal; and to automatically generate, based on the estimated emotional state and the associated generation history, a new prompt sentence including an improvement proposal for the visual representation or the voice representation, and, upon receiving a selection of the new prompt sentence from the user, to re-input the new prompt sentence into at least one generative AI model and execute a controlled regeneration process using cached model configurations and shared computational resources. This enables a technically improved, server-centric orchestration of multiple generative AI models in which prompt construction, model selection, emotion-aware adaptation, and media post-processing are unified within a single processing pipeline, thereby reducing client-side complexity, improving the consistency and quality of generated outputs, decreasing redundant computation and network transfer, and enhancing the scalability and efficiency of the underlying computer system.

The term “processor” refers to a hardware computation unit, or a combination of hardware computation units, configured to execute machine-readable instructions, including a central processing unit, a graphics processing unit, a digital signal processor, or any combination thereof.

The term “system” refers to an arrangement of one or more processors, memories, communication interfaces, and storage devices that cooperatively execute instructions to perform the functions described in the claims.

The term “user” refers to a human operator who interacts with the system via an information processing terminal to provide inputs and receive outputs.

The term “information processing terminal” refers to an electronic device having at least a processor, a memory, a communication interface, and a display, and configured to transmit data to and receive data from the server, such as a smartphone, a tablet, a personal computer, or a similar device.

The term “attribute information” refers to information indicating personal or profile-related characteristics associated with the user or with a virtual character, including but not limited to age category, gender category, personality category, and preference category.

The term “feature information” refers to detailed parameters specifying characteristics of a virtual character, including physical features, decorative features, and expression styles.

The term “physical features” refers to feature information indicating structural and appearance-related aspects of a virtual character's body, including hair characteristics, eye characteristics, facial characteristics, body shape characteristics, and posture characteristics. The term “decorative features” refers to feature information indicating non-structural elements associated with a virtual character, including clothing, accessories, background elements, and color schemes.

The term “expression styles” refers to feature information defining the visual or stylistic manner in which the virtual character is depicted, including drawing style, realism level, mood, and lighting style.

The term “structured data” refers to data represented in a machine-readable format having an explicit structure, such as key-value pairs, lists, or hierarchical objects, including formats such as JavaScript Object Notation, extensible markup language, or equivalent representations.

The term “prompt sentence” refers to a natural-language text string that describes desired content, style, or behavior of a generated output and is provided as an input to a generative AI model.

The term “generation instruction information” refers to data that includes at least one prompt sentence and may further include control parameters such as resolution, output format, style information, and model selection directives for use by a generative AI model.

The term “style information” refers to data indicating a desired appearance, atmosphere, or manner of presentation of generated content, including art style, color tone, lighting, mood, and level of detail.

The term “generative AI model” refers to a machine-learned model configured to generate data samples, such as images, text, or audio, in response to one or more inputs including a prompt sentence and optional control parameters.

The term “image generative AI model” refers to a generative AI model configured to output digital image data representing a visual object or scene, in response to an input including a prompt sentence.

The term “voice generative AI model” refers to a generative AI model configured to output digital audio data representing speech or voice, in response to an input including a prompt sentence or text information and voice parameters.

The term “visual representation” refers to digital image data that depicts a virtual character, including still images, illustrations, or rendered graphics.

The term “voice representation” refers to digital audio data that represents synthesized speech, vocal expressions, or character voices.

The term “virtual character” refers to a digitally represented entity, such as a human-like, animal-like, or imaginary avatar, whose appearance and behavior are defined by attribute information and feature information.

The term “character information” refers to text data entered by the user in a chat or message interface, representing statements, requests, feedback, or comments.

The term “symbol information” refers to non-alphabetic characters included in user input, such as emoticons, emojis, punctuation marks, and special symbols that contribute to expressing the user's emotional state.

The term “chat format” refers to an interaction mode in which the user transmits and receives messages consisting of character information and symbol information in a temporal sequence similar to instant messaging.

The term “natural language processing module” refers to a software component or combination of software and hardware configured to analyze and process natural language text, including tokenization, parsing, embedding generation, and semantic interpretation.

The term “emotion classification module” refers to a software component or combination of software and hardware, including a machine-learned model, configured to estimate an emotional state from input text or symbols by assigning one or more emotion labels or scores.

The term “emotional state” refers to an internal state of the user inferred by the system, including categories such as satisfaction, dissatisfaction, happiness, sadness, anxiety, or confusion.

The term “response prompt sentence” refers to a prompt sentence that is automatically generated by the processor based on the estimated emotional state and that is used as input to a generative AI model to generate a message or other content intended to respond to the user.

The term “message” refers to a unit of content generated by a generative AI model based on a prompt sentence, including text, combined text and symbols, or other natural-language output presented to the user.

The term “post-processing” refers to processing applied to data generated by a generative AI model, including resizing, cropping, filtering, background manipulation, format conversion, quality adjustment, and similar transformations.

The term “image size” refers to the dimensions of an image in pixels or other spatial units.

The term “image shape” refers to the aspect ratio or geometric configuration of an image.

The term “image quality” refers to characteristics of an image related to clarity and fidelity, including resolution, compression degree, noise level, and color accuracy.

The term “background” refers to a region or component of an image that is not part of the main subject and may be modified independently of the main subject.

The term “storage device” refers to a physical or virtual device configured to hold digital data in a non-transitory manner, including magnetic storage, solid-state storage, optical storage, or network-based storage.

The term “reference information” refers to data that enables identification or retrieval of stored media, such as a file path, a uniform resource locator, an identifier, or a database key.

The term “text information” refers to a sequence of characters representing linguistic content, such as words and sentences, used as input for voice generation.

The term “speaker style information” refers to data specifying desired characteristics of a synthesized voice, including speaker identity category, gender category, age category, accent, and expressiveness.

The term “audio format” refers to a standardized encoding format for digital audio data, such as a waveform format or a compressed audio format.

The term “generation history” refers to logged information associated with past generation operations, including used prompt sentences, selected models, parameter values, and produced outputs.

The term “improvement proposal” refers to a modification or extension of an existing prompt sentence or parameter set, automatically derived by the processor, that is intended to adjust or enhance a generated visual representation or voice representation.

The term “regeneration process” refers to a process in which a generative AI model is invoked again with a new or modified prompt sentence or parameters in order to generate an updated output.

The term “template” refers to a predefined pattern or structure comprising fixed text segments and insertion positions into which feature information or other data is placed to form a complete prompt sentence.

The term “parameter” refers to a numeric or categorical value that controls the behavior of a generative AI model, including emotional tone, speaking rate, voice quality, resolution, and style settings.

The term “emotional tone” refers to a parameter that affects how a voice representation or textual message conveys affect, such as cheerful, calm, or serious.

The term “speaking rate” refers to a parameter indicating the speed at which synthesized speech is generated, typically measured in units such as syllables per second or words per minute.

The term “voice quality” refers to characteristics of a synthesized voice, including timbre, pitch range, and degree of roughness or breathiness.

The term “plurality of types of voice data” refers to two or more different audio outputs generated by varying at least one parameter such as emotional tone, speaking rate, or voice quality.

The term “selection of the user” refers to an operation performed via the information processing terminal in which the user chooses one option from among a plurality of presented candidates, such as prompt variants or voice samples.

In one embodiment, a server cooperates with one or more terminals used by users to realize the claimed system. The server includes at least one processor, a main memory, a non-transitory storage device, and a network interface. The server executes server-side software implemented, for example, using a web application framework and a machine learning framework. The server may execute a web service stack implemented with a general-purpose programming language and a deep learning library such as a tensor computation library on a graphics processing unit. The server may further employ a natural language processing toolkit and an HTTP server software. The terminal includes at least a processor, a memory, a display, a user input interface, and a communication interface, and may be implemented as a smartphone, a tablet, or a personal computer executing an operating system and a web browser or a native application.

The server stores, in the storage device, one or more trained generative AI models, including at least an image generative AI model and a voice generative AI model. In one example, the server uses a diffusion-type image generative AI model that follows a latent diffusion architecture: a text encoder (for example, a transformer-based encoder) converts a prompt sentence into a sequence of embedding vectors; a denoising network (for example, a U-Net convolutional neural network with attention layers) iteratively denoises a latent representation; and a decoder (for example, a variational autoencoder) reconstructs a pixel-space image from the latent representation. The server also stores a voice generative AI model that may include a sequence-to-sequence text-to-spectrogram network (for example, an encoder-decoder recurrent or transformer architecture) and a neural vocoder (for example, a convolutional or autoregressive model) that converts spectrograms into waveform audio.

The server stores, in memory or in the storage device, a set of templates for generating prompt sentences. Each template includes fixed text segments and placeholder tokens corresponding to types of feature information. For example, the server may store a template such as: “Please generate a character with {hair_color} hair, {eye_color} eyes, and a {body_type} body type in an anime illustration style.” The server associates each placeholder token with a key in a structured data representation, such as a key-value pair.

The terminal presents, on the display, a graphical user interface that allows the user to specify feature information. The terminal may display input components such as dropdown lists for hair color, eye color, and body type; checkboxes for decorative features such as “glasses” or “hat”; and radio buttons or selection lists for style information such as “anime style,” “realistic style,” or “chibi style.” The terminal converts the user selections into structured data in memory, such as an object with multiple fields. The terminal then transmits this structured data to the server via the network interface using a communication protocol such as HTTPS.

The server receives the structured data from the terminal and converts the data into an internal representation suitable for prompt generation. The server may explicitly map each field of the structured data to a canonical token or phrase. For example, the server may map a hair color option “red” to the phrase “red hair,” an eye color option “blue” to the phrase “blue eyes,” and a body type option “muscular” to the phrase “a muscular body type.” The server performs this mapping using a rule-based transformation table or a small embedding-based similarity search that selects standardized phrases, thereby normalizing the input features across different user inputs.

The server generates a prompt sentence by inserting the mapped phrases into a selected template. The server may select the template according to the type and number of specified features, or according to style information. For example, when the user specifies a simple set of features, the server may generate the following prompt sentence:
“Please generate a character with red hair, blue eyes, and a muscular body type in an anime illustration style.”

When the user specifies more advanced style information, the server may generate a more complex prompt sentence such as:
“Generate a 2D game character with long silver hair, green eyes, and a slim body type, wearing a futuristic battle suit, in a cel-shaded anime style with a white background and high detail.”

The server stores the generated prompt sentence together with the structured data in memory and optionally in the storage device for later reference. By using structured data and predefined templates, the server ensures that the prompt sentence follows a consistent format that the generative AI models handle efficiently, thereby reducing prompt variability and improving output stability.

The server analyzes the generated prompt sentence using a natural language processing module. The server may tokenize the prompt sentence, remove extraneous characters, and convert the tokens into numerical representations using a tokenizer associated with the generative AI model. The server may also classify the style from the prompt sentence using a lightweight classifier to determine whether the content is, for example, anime-style, realistic-style, or comic-style. Based on the classification and system configuration, the server selects an appropriate image generative AI model. For example, the server may route anime-style prompts to a diffusion-based model optimized for illustrations, and route realistic prompts to a different generative AI model optimized for photographic images.

The server executes the image generative AI model using a hardware accelerator, such as a GPU, to perform matrix multiplications, attention computations, and convolution operations. The server loads model parameters (weights) from the storage device into GPU memory. The server then executes a deterministic or pseudo-random sampling process defined by the diffusion model, including a sequence of T denoising steps. In each step, the server uses the denoising network to predict noise and updates the latent representation according to a numerical scheme, such as a stochastic differential equation solver or a discrete noise schedule. The server then decodes the final latent representation into an image tensor using the decoder network. The server transfers the resulting image tensor from GPU memory to main memory and converts the tensor into pixel data.

The server performs post-processing on the pixel data. The server may use an image processing library to resize the image to a desired resolution, crop unnecessary margins, adjust brightness and contrast, or apply background manipulation. The server may, for example, set a standardized output size (such as 1024×1024 pixels) to reduce downstream memory usage and bandwidth consumption. The server encodes the post-processed image into a compressed file format such as JPEG or PNG, balancing quality and file size according to predefined parameters. The server stores the encoded image in a storage device such as a solid-state drive or a network-attached storage, and generates a unique identifier or a URL that serves as reference information. The server then transmits this reference information to the terminal.

The terminal receives the reference information and retrieves the image from the storage device via the network. The terminal displays the retrieved image on the display. The user can visually inspect the generated virtual character and may store the image locally. By standardizing image size and encoding parameters server-side, the system reduces the amount of data transmitted, lowering communication load and improving user-perceived latency, which constitutes a technical improvement over conventional systems that leave such tasks to the client.

The server also generates voice representations of the virtual character. The server receives, from the terminal, text information and speaker style information selected by the user, such as “energetic,” “calm,” or “serious.” The server maps the style information to numerical parameters controlling emotional tone, speaking rate, and voice quality. For example, the server may map “energetic” to a higher pitch parameter, a faster speaking rate parameter, and higher prosody variation. The server constructs a voice generation prompt sentence by combining the text information with style descriptors, and then provides both the text and the mapped numerical parameters to the voice generative AI model.

The server executes the voice generative AI model by feeding tokenized text and style embeddings into an encoder-decoder architecture that outputs a sequence of acoustic feature frames, such as mel-spectrograms. The server uses a neural vocoder to convert the acoustic features into a waveform. During generation, the server uses a specific loss-minimized set of model weights obtained through supervised training on paired text-audio data, where the training procedure uses an error function such as a mean squared error between predicted and target spectrograms, a sequence alignment loss, and an adversarial loss for waveform realism. The server caches intermediate model activations to accelerate generation of multiple voice candidates with different parameter settings. The server encodes the resulting waveform into a compressed audio format and stores it in the storage device, again generating reference information and sending it to the terminal.

The terminal plays back the received voice data using an audio playback interface. The user can compare multiple voice candidates generated under different parameter settings and select one as the final voice representation. Because the server reuses cached computations and shared model configurations when generating multiple candidates, the system reduces redundant computation, leading to improved processing throughput and energy efficiency compared with naïve, independent generation for each candidate.

The server integrates emotion analysis into the generation pipeline. The user may enter free-form feedback or conversation text using a chat interface on the terminal, including symbols such as emoticons and punctuation. The terminal transmits the text and symbols to the server. The server applies a natural language processing module that tokenizes the text, maps tokens to embeddings, and passes the sequence through an emotion classification network. The network may be a transformer-based classifier trained to output a probability distribution over emotion categories such as “satisfied,” “dissatisfied,” “joyful,” “sad,” or “anxious.” During training, the server may use a cross-entropy loss function comparing predicted probabilities with ground-truth labels and may apply data augmentation such as synonym replacement or emoji variants to improve robustness.

The server estimates an emotional state based on the classification output and constructs a response prompt sentence for a text generative AI model. For example, if the system detects dissatisfaction, the server may generate a response prompt sentence such as:
“Generate a friendly and reassuring message that acknowledges the user is not satisfied with the current character and suggests making the character's expression more gentle and smiling.”

The server supplies this prompt sentence, together with contextual information about the previously generated character, to a text generative AI model. The text generative AI model may be a transformer-based language model configured to output a natural language message. The server then provides the generated message to the terminal, which displays the message in the chat interface. Because the server constructs the response prompt sentence using explicit, rule-based and model-assisted logic tied to emotion categories, the system can systematically and reproducibly adjust the behavior of the generative models according to user state, which is different from a simple manual chat reply.

The server further generates new prompt sentences as improvement proposals for visual or voice representations. The server uses the structured data, the original prompt sentence, and the emotion classification result to modify or extend the feature information. For example, when the user complains that “the face looks too serious,” the server adds or replaces feature information related to facial expression, and constructs a new prompt sentence such as:
“Generate the same character, but with a gentle smile and bright, friendly eyes.”

The server stores this new prompt sentence as part of the generation history. When the user selects this improvement proposal on the terminal, the server reuses cached model configurations and previously computed text encodings to reduce the computational cost of regeneration. The server inputs the new prompt sentence to the image generative AI model and regenerates the image. This reuse of intermediate representations constitutes a non-conventional computational process that reduces redundant encoding and model loading operations, leading to faster regeneration and lower resource consumption.

In additional embodiments, the server may implement alternative architectures for the generative AI models. For example, the server may use a generative adversarial network architecture for image generation, with a generator and discriminator trained using an adversarial loss combined with a perceptual loss. The server may also employ different text encoders, such as recurrent neural networks, and alternative audio generation architectures, such as non-autoregressive vocoders. The system may select among multiple architectures based on model performance, latency constraints, or hardware availability.

The server may also employ different data structures for internal representations. For example, the server may maintain a relational database schema that records for each generation request: a request identifier, user identifier, structured feature data, prompt sentence, selected model identifier, parameter settings, generated output identifiers, and emotion analysis results. The server may query this database to analyze patterns, suggest default settings, or pre-compute embeddings for common combinations of features, thereby speeding up subsequent prompt processing and model invocation.

The server uses the combination of structured feature mapping, template-based prompt construction, model-aware preprocessing, emotion-aware control flow, and standardized post-processing to improve the functioning of the computer system itself. By constraining and normalizing prompt sentences using templates and structured data, the server reduces the variance of model inputs and makes internal caching and batching strategies more effective. By integrating emotion analysis into the generation logic, the server can anticipate likely regeneration requests and prepare reusable intermediate encodings. By performing post-processing and media encoding server-side using standardized dimensions and formats, the server reduces network bandwidth usage and avoids the need for each terminal to implement its own image and audio processing. These features collectively yield technical effects including improved processing speed, reduced error rates in content generation, and lower communication overhead, rather than merely automating human creative work.

In a variation, the server may operate in a distributed computing environment, where different microservices handle prompt construction, model selection, image generation, audio generation, and emotion analysis. The server may use a message queue to pass structured data between services, and may use a centralized feature store to share templates and normalization rules. The terminal behavior remains similar: the terminal collects user inputs, displays outputs, and forwards structured data and user selections to the server.

The terminal may be implemented as a native application or as a web application. In either case, the terminal presents user interface elements that expose a reduced and normalized set of feature parameters, thereby guiding the user toward combinations that correspond to stable prompt structures. The terminal may display preview text of the generated prompt sentence so that the user can optionally edit the prompt sentence manually, but the server continues to apply its own normalization and mapping logic before sending the prompt sentence to the generative AI models.

Through these embodiments, the server uses concrete data structures, specific neural network architectures, and a defined flow of feature mapping, prompt generation, model selection, and post-processing. The cooperation of the server and the terminal leads to an improvement in computer-implemented generation of visual and voice content, in terms of computational efficiency, quality consistency, and adaptability to user emotional state, rather than merely replacing human manual operations.

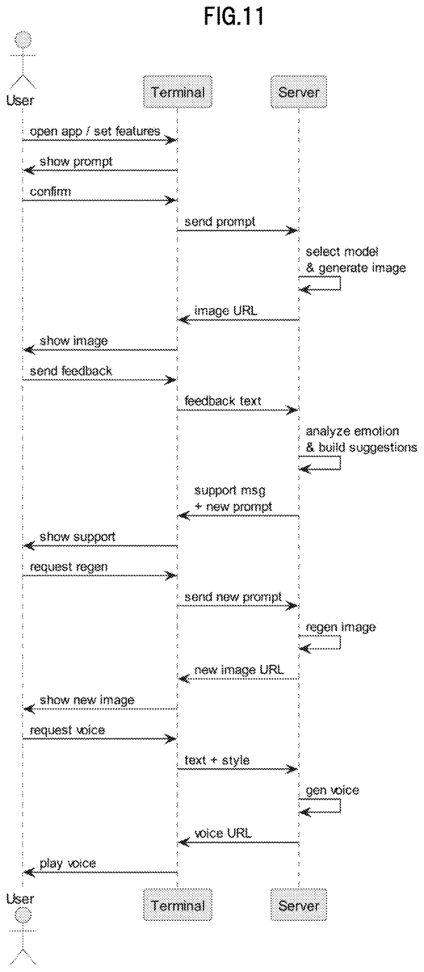

The following describes the processing flow using FIG. 11.

### Step 1:

The user operates the terminal to launch an application or web browser and opens a character creation screen.

The terminal displays input controls such as text fields, dropdown lists, sliders, and checkboxes for attribute information and feature information, including hair color, eye color, body type, decorative items, and style options.

Input: The user inputs selections and text into the GUI components.

Processing: The terminal reads the values from the GUI components, validates them (for example, checks that required fields are not empty and that values are within allowed ranges), and converts them into an internal structured representation such as key-value pairs in memory.

Output: The terminal generates structured feature data representing the user's selections.

### Step 2:

The terminal converts the structured feature data into a prompt sentence candidate.

Input: The terminal receives the structured feature data created in Step 1.

Processing: The terminal maps each feature (for example, “red” for hair color, “blue” for eye color, “muscular” for body type) to standardized phrases such as “red hair,” “blue eyes,” and “a muscular body type,” and inserts these phrases into a predefined text template. The terminal concatenates multiple phrases and fixed text segments to form a grammatically correct natural-language string.

Output: The terminal generates a prompt sentence such as “Please generate a character with red hair, blue eyes, and a muscular body type in an anime illustration style.”

### Step 3:

The terminal presents the generated prompt sentence to the user for confirmation or manual editing.

Input: The terminal receives the prompt sentence generated in Step 2.

Processing: The terminal displays the prompt sentence in an editable text area, allowing the user to review and modify the phrase structure or add additional instructions. If the user edits the prompt sentence, the terminal updates the internal string in memory.

Output: The terminal holds a confirmed prompt sentence string that reflects the user's final intent.

### Step 4:

The user confirms the character generation request.

Input: The user checks the displayed prompt sentence and presses a “Generate character” button or equivalent control.

Processing: The user triggers an event in the terminal UI. The terminal associates the event with the current prompt sentence and structured feature data.

Output: The terminal determines that the prompt sentence and associated data are ready to be sent to the server.

### Step 5:

The terminal transmits the prompt sentence and structured feature data to the server.

Input: The terminal holds the confirmed prompt sentence and structured feature data from Steps 2 and 3.

Processing: The terminal constructs a request payload containing the prompt sentence, feature data, a request identifier, and optional metadata such as desired resolution, image format, and style flags. The terminal serializes this payload into a structured message, for example a JSON object, and sends it to the server via a secure communication protocol such as HTTPS.

Output: The server receives a network request containing the prompt sentence and associated metadata.

### Step 6:

The server receives and parses the character generation request.

Input: The server receives the HTTPS request from the terminal containing the prompt sentence, feature data, and metadata.

Processing: The server uses a web application framework to parse the request body, extract the prompt sentence, the structured feature data, and the metadata fields, and store them temporarily in server memory. The server validates the content (for example, checks length limits and allowed characters) and records a log entry or database record with a timestamp and the request identifier.

Output: The server generates an internal request object that encapsulates the validated prompt sentence, feature data, and metadata.

### Step 7:

The server normalizes the prompt sentence and derives model selection information.

Input: The server receives the internal request object with the prompt sentence and feature data.

Processing: The server performs natural language preprocessing on the prompt sentence, including lowercasing, trimming whitespace, and replacing unsupported characters. The server analyzes the prompt sentence to detect style keywords and content categories (for example, “anime,” “realistic,” or “2D game character”) using rule-based pattern matching or a small classifier. Based on the detected categories and system configuration, the server selects an appropriate image generative AI model and associated tokenizer and decoder.

Output: The server produces a model selection decision and a normalized prompt sentence ready for tokenization.

### Step 8:

The server converts the normalized prompt sentence into model-specific input data.

Input: The server receives the normalized prompt sentence and the selected image generative AI model identifier from Step 7.

Processing: The server uses the tokenizer associated with the selected generative AI model to split the prompt sentence into tokens and map each token to a token ID. The server then embeds the token IDs into continuous vectors using the model's text encoder. The server may pad or truncate the token sequence to fit the model's maximum input length and store the resulting embedding sequence in GPU memory.

Output: The server generates text embeddings that represent the semantic content of the prompt sentence in a numerical form.

### Step 9:

The server generates a latent representation of the image using the image generative AI model.

Input: The server receives the text embeddings from Step 8 and model hyperparameters such as the number of denoising steps, guidance scale, and random seed.

Processing: The server initializes a latent tensor representing noisy image features and repeatedly applies a denoising network (for example, a U-Net with attention layers) in a diffusion process. At each step, the server combines the noisy latent tensor with the text embeddings and computes updated latent values using matrix multiplications, convolutions, and non-linear activation functions. The server follows a predefined noise schedule to progressively reduce noise and refine the latent representation.

Output: The server produces a final latent image tensor that encodes the visual concept specified by the prompt sentence.

### Step 10:

The server decodes the latent representation into pixel data and applies image post-processing.

Input: The server receives the final latent image tensor from Step 9.

Processing: The server uses a decoder network, such as the decoder of a variational autoencoder, to convert the latent tensor into a high-resolution image tensor in pixel space. The server transfers this tensor from GPU memory to main memory and applies image processing operations such as resizing, cropping, background adjustment, and color correction. The server then encodes the processed image tensor into a compressed image file format such as PNG or JPEG using an image codec.

Output: The server generates a finalized image file representing the visual representation of the virtual character.

### Step 11:

The server stores the generated image and returns reference information to the terminal.

Input: The server receives the finalized image file from Step 10.

Processing: The server writes the image file to a storage device, such as a solid-state drive or object storage, under a unique filename or identifier. The server constructs reference information, for example a URL or a resource identifier, that allows later retrieval of the image. The server embeds the reference information and associated metadata (such as resolution and file size) into a response message.

Output: The server sends a response to the terminal containing the reference information and metadata of the generated image.

### Step 12:

The terminal retrieves and displays the generated image.

Input: The terminal receives the server response containing the image reference information from Step 11.

Processing: The terminal uses the reference information to download the encoded image file via the network. The terminal decodes the image file into pixel data using a local image decoding library and renders the pixel data onto the display using its graphics framework. The terminal may scale or fit the image to the screen size and update the UI to remove any loading indicators.

Output: The terminal presents the generated virtual character image on the display for the user to view.

### Step 13:

The user provides feedback and emotional content through a chat interface.

Input: The user observes the displayed image and types free-form text comments, optionally including emoticons and symbols, into a chat input field on the terminal.

Processing: The user may express satisfaction, dissatisfaction, or specific requests such as “I am not satisfied with this character; the face looks too serious :(”. The terminal captures the entire text string, along with message metadata such as a timestamp and an associated image identifier.

Output: The terminal holds user feedback text and symbol information ready to send to the server.

### Step 14:

The terminal transmits the feedback text and symbol information to the server.

Input: The terminal receives the feedback text and symbol information generated in Step 13.

Processing: The terminal constructs a feedback payload containing the text content, symbol content, user identifier (if applicable), and associated image identifier. The terminal serializes this payload, for example into JSON, and sends it to the server via HTTPS.

Output: The server receives a feedback request containing character information and symbol information.

### Step 15:

The server performs emotion analysis on the feedback and determines an emotional state.

Input: The server receives the feedback request with text and symbol information from Step 14.

Processing: The server tokenizes the text, maps tokens to embeddings using a language model encoder, and optionally converts symbols such as emojis into special tokens. The server feeds the embedding sequence into an emotion classification network, such as a transformer-based classifier, which outputs a probability distribution over emotion categories. The server computes the most likely emotion label (for example, “dissatisfied” or “confused”) and may also store confidence scores.

Output: The server generates an estimated emotional state and associated probabilities for the feedback message.

### Step 16:

The server constructs a response prompt sentence based on the emotional state and generation history.

Input: The server receives the estimated emotional state from Step 15 and the original generation history including the prompt sentence and feature data.

Processing: The server applies rule-based logic to determine how to respond. For example, when the emotional state is “dissatisfied” and the feedback mentions “face looks too serious,” the server identifies facial expression as a target feature for adjustment. The server creates a response prompt sentence for a text generative AI model, such as “Generate a friendly and reassuring message that acknowledges the user's dissatisfaction and suggests making the character's expression more gentle and smiling.” The server may also construct a new improvement prompt sentence for image regeneration, such as “Generate the same character, but with a gentle smile and bright, friendly eyes.”

Output: The server produces a response prompt sentence for message generation and an optional improvement prompt sentence for image regeneration.

### Step 17:

The server generates a support message using a generative AI model and returns it to the terminal.

Input: The server receives the response prompt sentence for message generation from Step 16.

Processing: The server tokenizes the response prompt sentence and feeds the tokenized input to a text generative AI model, such as a transformer-based language model. The server runs the model's decoding algorithm (for example, greedy decoding or beam search) to generate a natural-language support message. The server packages the generated message together with the improvement prompt sentence into a response structure.

Output: The server sends the support message and the improvement prompt sentence to the terminal.

### Step 18:

The terminal displays the support message and offers the improvement prompt as a selectable option.

Input: The terminal receives the support message and the improvement prompt sentence from Step 17.

Processing: The terminal displays the support message in the chat interface and presents the improvement prompt sentence either as readable text or as a button labeled, for example, “Regenerate with suggested changes.” The terminal associates a user action on this button with the improvement prompt sentence.

Output: The terminal provides an interactive UI that lets the user initiate regeneration using the improvement prompt sentence.

### Step 19:

The user chooses to regenerate the character using the improvement prompt sentence.

Input: The user reads the support message and selects the regeneration option presented in Step 18.

Processing: The user activates a control on the terminal, such as tapping a button, which signals consent to use the improvement prompt sentence. The terminal takes the improvement prompt sentence, optionally displays it for confirmation, and prepares a new generation request.

Output: The terminal holds a confirmed improvement prompt sentence and associated metadata for a new generation cycle.

### Step 20:

The terminal sends the improvement prompt sentence to the server for regeneration.

Input: The terminal receives the improvement prompt sentence from Step 19.

Processing: The terminal constructs a new request payload that includes the improvement prompt sentence, original feature data, and a reference to the previous generation. The terminal transmits this payload to the server using HTTPS, optionally adding a flag indicating that this is a regeneration request.

Output: The server receives a regeneration request containing the improvement prompt sentence.

### Step 21:

The server reuses cached information and regenerates the image using the improvement prompt sentence.

Input: The server receives the regeneration request and the improvement prompt sentence from Step 20, along with any stored encodings or model configurations from the original generation.

Processing: The server retrieves cached text embeddings or model configurations associated with the original prompt sentence and updates only the parts affected by the improvement phrase. For example, the server may recompute embeddings for the modified segment “with a gentle smile and bright, friendly eyes” while reusing previous embeddings for unchanged portions. The server then repeats the diffusion-based latent generation and decoding process with the updated embeddings, thereby generating a modified image that reflects the new facial expression.

Output: The server produces a regenerated image file and corresponding reference information, and sends the reference information to the terminal.

### Step 22:

The terminal updates the displayed image with the regenerated character.

Input: The terminal receives the new reference information for the regenerated image from Step 21.

Processing: The terminal retrieves the regenerated image from the storage device, decodes it, and replaces or supplements the previously displayed character image on the display. The terminal may visually indicate that this is the updated version based on user feedback.

Output: The terminal presents the regenerated virtual character to the user.

### Step 23:

The user requests a voice representation associated with the virtual character.

Input: The user observes the current character image and selects a voice option on the terminal, such as choosing an emotional tone and a speaking style.

Processing: The user provides voice-related parameters via a UI panel that may include sliders for speaking rate, dropdown lists for tone (for example, “cheerful,” “calm,” “serious”), and options for voice gender or age. The terminal captures these parameters and combines them with text content, such as a sample line the character should speak.

Output: The terminal produces voice input parameters including text information and speaker style information.

### Step 24:

The terminal sends the voice generation request to the server.

Input: The terminal holds the voice input parameters collected in Step 23.

Processing: The terminal forms a request payload including the text to be spoken, the selected tone, speaking rate, voice quality parameters, and a reference to the associated character. The terminal sends this payload to the server via HTTPS.

Output: The server receives a voice generation request with text information and style parameters.

### Step 25:

The server generates one or more voice representations using the voice generative AI model.

Input: The server receives the voice generation request from Step 24.

Processing: The server converts the text into token IDs and maps the style parameters (tone, speaking rate, voice quality) to numerical control vectors. The server feeds the token IDs and control vectors into a text-to-spectrogram network to compute acoustic feature sequences. The server then uses a neural vocoder to convert these features into audio waveforms. The server may generate multiple candidate voice samples by varying one or more parameters within defined ranges. The server encodes each waveform into an audio format such as MP3 or WAV and stores them in the storage device, creating reference information for each sample.

Output: The server sends to the terminal the reference information for the generated voice samples and optional metadata such as duration and parameter values.

### Step 26:

The terminal plays back the generated voice samples and allows the user to select one.

Input: The terminal receives reference information for the voice samples from Step 25.

Processing: The terminal retrieves the corresponding audio files from the storage device via the network, decodes the audio data, and presents playback controls on the UI. The user can listen to each sample by pressing play buttons. The terminal records the user's selection when the user chooses a preferred sample.

Output: The terminal identifies the selected voice sample and may associate it as the final voice representation of the virtual character.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional avatar customization and virtual communication systems typically rely on static parameter mappings between user inputs and predesigned assets. In many implementations, a user selects discrete options, such as hair color or body type, and a client application merely switches between predefined images or models. Likewise, conversational functions often employ simple rule-based scripts or shallow sentiment scores that are not deeply integrated with avatar generation or voice behavior. As a result, such systems suffer from several technical limitations.

First, the system-side processing does not effectively utilize generative AI models in a unified and structured manner. Input attributes, dialog context, and emotional signals are not translated into coherent prompt sentences that can drive image, text, and voice generative models in a coordinated fashion. This leads to fragmented processing pipelines, redundant computation, and difficulties in maintaining consistency between an avatar's appearance, its voice characteristics, and its conversational behavior.

Second, the real-time update of avatars is technically constrained. Many existing systems either regenerate entire assets on the client or download large, static resources from a server, which increases bandwidth usage and latency. There is no systematic mechanism in which a server dynamically generates and refines prompt sentences, re-invokes generative models with updated conditions, and incrementally updates the avatar's image data or three-dimensional data in real time in response to fine-grained attribute changes from the user. This results in sluggish user interfaces and limited responsiveness in virtual environments.

Third, emotion analysis from user dialog is often decoupled from the avatar generation pipeline. Even when a server applies natural language processing to chat messages, the resulting emotional assessment is typically used only to select from a fixed set of canned responses, without feeding back into the generative AI models that control the avatar's visual expression, voice style, or the semantic content of replies. Consequently, the system fails to technically exploit accumulated conversation history to adjust generation conditions and prompt formulations in a way that improves personalization, coherence, and long-term adaptation at the system level.

Fourth, existing architectures do not provide an efficient, machine-implemented mechanism to represent heterogeneous inputs—attribute information, text, and emoji—as higher-level concept descriptions and to drive multiple generative models using those descriptions as unified control signals. This lack of a prompt-centric orchestration layer complicates system design, leads to ad hoc integrations, and limits scalability when extending to new modalities or behaviors.

Accordingly, there is a need for an improved computer-implemented system and server-side processing architecture that: (i) converts user attributes and dialog signals into structured prompt sentences expressed at a higher conceptual level; (ii) coordinates generative AI models for image, voice, and text based on those prompt sentences; (iii) performs real-time updates of avatar data in a virtual space; and (iv) progressively optimizes generation conditions using accumulated emotional and conversational history. Such improvements are directed to enhancing the functioning of the computer system itself, including more efficient use of generative models, better state management, and reduced latency and bandwidth overhead in interactive virtual environments.

The specific processing by the specific processing unit 290 of the data processing device 12 in Application Example 1 is realized by the following means.

The present invention provides a server comprising a processor configured to receive, from an information processing terminal, attribute information representing characteristics of a virtual object, convert the attribute information into a natural language description expressed in terms of higher-level concepts, and generate one or more prompt sentences that instruct one or more generative AI models to perform generation processing for the virtual object; to analyze, using a natural language processing model and an emotion estimation model, character information and symbol information received from the information processing terminal in a chat format, estimate an emotional state of a user, and generate one or more prompt sentences that instruct a generative AI model to generate response content configured to provide psychological stability to the user based on the estimated emotional state and attributes of the virtual object; to sequentially receive update information of the attribute information from the information processing terminal, generate updated prompt sentences reflecting the update information, and re-input the updated prompt sentences to at least one generative AI model so as to update, in real time, image data and/or three-dimensional shape data of the virtual object and cause an updated virtual object to be presented as an avatar in a virtual space; and to accumulate, as conversation history, emotion estimation results and related dialog context, and dynamically adjust contents of the prompt sentences and generation conditions of the generative AI models based on the conversation history so as to continuously optimize an appearance of the virtual object, voice characteristics, and response content for each individual user. This enables a computer-implemented system in which server-side processing functions as a prompt-centric orchestration layer that efficiently coordinates multiple generative AI models, reduces redundant data transfer and processing, provides low-latency real-time avatar updates, and adaptively personalizes multimodal outputs based on accumulated user interaction and emotional state, thereby improving the technical performance and responsiveness of virtual avatar systems.

The term “system” refers to an arrangement of one or more hardware devices and software components that cooperate to execute processing for generating, updating, and presenting a virtual object based on user inputs and outputs of one or more generative AI models. The term “processor” refers to a hardware processing unit, such as a central processing unit or a graphics processing unit, configured to execute machine-readable instructions to perform the functions described for the server, including generating prompt sentences, invoking generative AI models, and controlling data transmission to and from terminals.

The term “information processing terminal” refers to an electronic device operated by a user, such as a smartphone, tablet, head-mounted display, or personal computer, that is configured to send attribute information and dialog information to a server and to present visual and/or audio information received from the server.

The term “user” refers to a person or an entity that operates the information processing terminal to input attribute information, transmit dialog information, and view or listen to content related to a virtual object or avatar.

The term “attribute information” refers to data representing characteristics of a virtual object, including but not limited to color, shape, size, style, and behavioral preferences, which are specified by a user or derived from user behavior.

The term “virtual object” refers to a computer-generated entity, such as a virtual character or avatar, represented by image data, three-dimensional shape data, and/or associated audio data, and presented within a digital environment.

The term “avatar” refers to a representation of a user or a virtual entity in a virtual space, implemented by visual data and optionally audio data, which may be controlled or influenced by the user's inputs and the system's generative processing.

The term “virtual space” refers to a computer-generated environment in which one or more virtual objects or avatars are displayed and may interact, including two-dimensional and three-dimensional environments rendered on an information processing terminal.

The term “generative AI model” refers to a machine-learning-based model, such as a neural network, configured to generate data outputs including image data, audio data, or text data in response to input data such as prompt sentences or feature representations.

The term “prompt sentence” refers to a text-based input expression, typically in natural language, that encodes conditions, constraints, or descriptions and is supplied to a generative AI model to control or guide the content of generated outputs.

The term “natural language description” refers to a sequence of words and phrases in a human language that expresses characteristics or conditions of a virtual object at a conceptual level suitable for driving a generative AI model.

The term “higher-level concepts” refers to abstracted descriptions of attributes or states that generalize specific parameter values into semantically richer categories, enabling a generative AI model to generate consistent and coherent outputs.

The term “image data” refers to digital data representing a two-dimensional visual depiction of a subject, such as a virtual object or avatar, including pixel-based formats and texture data for application to three-dimensional models.

The term “three-dimensional shape data” refers to digital data representing the geometry of a three-dimensional object, including surface meshes, volumetric data, or other geometric representations suitable for rendering the virtual object in three dimensions.

The term “voice data” refers to digital audio data representing speech or vocal sounds associated with a virtual object, including but not limited to synthesized speech signals generated by a generative AI model.

The term “voice signal” refers to a time-varying digital or analog representation of sound corresponding to speech or vocalized output that can be reproduced by an audio output device.

The term “voice characteristics” refers to parameters representing properties of speech, including pitch, timbre, speaking rate, intonation, and style, which characterize how a virtual object or avatar sounds when outputting voice.

The term “voice characteristic information” refers to data specifying one or more voice characteristics, which may be used as conditions or control parameters for a generative AI model that generates voice data.

The term “speaking-style characteristic information” refers to data specifying nuances of speaking style, such as emotional tone, formality level, rhythm, and emphasis, which can be adjusted according to an estimated emotional state or dialog context.

The term “character information” refers to text-based data, including user-entered messages and system-generated messages, that are processed by the server for emotion estimation and response generation.

The term “symbol information” refers to non-alphabetic graphical tokens, such as emojis or pictograms, that convey emotional or contextual meaning in user messages and are used as features for emotion estimation.

The term “natural language processing model” refers to a machine-learning-based model configured to analyze, interpret, or generate human language text, and to extract features such as sentiment, intent, or semantic content from character information.

The term “emotion estimation model” refers to a machine-learning-based model or algorithm configured to infer an emotional state of a user from inputs such as character information, symbol information, and dialog context.

The term “emotional state” refers to a representation of a user's affective condition, such as happiness, sadness, anxiety, or calmness, that is estimated from user inputs and may be encoded as labels, scores, or continuous values.

The term “response content” refers to information generated by the system, including text, audio, or combined multimodal output, that is intended to be presented to a user in response to user inputs or emotional state.

The term “psychological stability” refers to a condition in which system-generated response content and behavior are configured to provide reassurance, comfort, or supportive interaction that reduces user anxiety or distress.

The term “chat format” refers to an interaction style in which messages are exchanged between the user and the system as discrete utterances or posts, typically displayed in chronological order in a conversational interface.

The term “conversation history” refers to stored data representing past interactions between the user and the system, including messages, emotion estimation results, and generated responses, which is used to inform future generation processing.

The term “generation conditions” refers to parameters, constraints, or contextual information applied to a generative AI model, including prompt sentence content, control settings, and model hyperparameters that influence generated outputs.

The term “real time” refers to processing and updating performed with a latency sufficiently low that a user perceives the response or update as occurring without noticeable delay during interactive operation.

The term “update information” refers to data indicating changes to previously supplied attribute information, such as modifications to appearance settings or behavioral preferences of a virtual object.

The term “appearance” refers to visual characteristics of a virtual object or avatar, including shape, color, texture, clothing, and style, as represented in image data or three-dimensional shape data.

The term “prompt-centric orchestration layer” refers to a server-side processing architecture that represents diverse control inputs and state information in the form of prompt sentences and uses those prompt sentences to coordinate multiple generative AI models.

In one embodiment, a server cooperates with one or more terminals operated by a user to implement a system for generating, updating, and presenting a virtual object using a generative AI model under control of a prompt sentence that is dynamically constructed from user inputs and dialog context.

A server includes at least one processor and at least one memory storing program instructions. A server connects to terminals over a communication network such as the Internet using a communication interface. A terminal is, for example, a smartphone, a tablet, a head-mounted display, or a personal computer, and includes a display device, an audio output device, a user input interface (touch screen, keyboard, microphone), and a network interface.

A server executes software components including: a web application framework (for example, a framework based on an HTTP server and an application server), an application logic module, a prompt generation module, a generative-model interface module, an emotion estimation module, a dialog management module, a data storage module (interfacing with a database such as a relational database), and a logging/monitoring module. A server also executes libraries and runtimes for machine learning frameworks, such as a numerical computation framework and a deep learning framework used to run the generative AI model.

A terminal executes a client application implemented, for example, as a browser-based web application using a script language and WebGL, or as a native application using a real-time graphics engine. A terminal renders images using a graphics processing unit and the operating system's graphics API, and plays audio via an audio API provided by the operating system.

In one embodiment, a server stores, in a database, attribute information schemas defining fields such as hair color, eye color, body type, clothing style, and other characteristics of a virtual object. A server also stores voice characteristic information schemas including fields such as base timbre identifier, pitch offset, speaking rate, and emotional tone. A server further stores conversation history in tables including user messages, symbol information, timestamps, estimated emotional states, and references to generated responses.

A server converts attribute information into a natural language description at a higher level of abstraction before supplying it as a prompt sentence to a generative AI model. For example, when a user specifies parameter-level attributes “hair: blue,” “eyes: green,” “body: slim,” and “style: casual,” a server generates a prompt sentence such as:

“Generate an avatar with blue hair, green eyes, and a slim body type, wearing casual clothing, in a clean anime style, full-body portrait.”

A server may also generate a more abstract prompt sentence such as:

“Generate a friendly, casual avatar with a light build, cool color tones, and relaxed clothing, suitable for social interaction in a virtual space.”

A server maps low-level attributes to such higher-level descriptors by using rule-based mappings stored in a configuration table and by using a learned mapping model. The learned mapping model is, for example, a neural network that takes as input a structured attribute vector and outputs a sequence of tokens representing descriptive phrases. This mapping model is trained using supervised learning with a loss function combining a language modeling loss and a semantic consistency loss that measures alignment between input attributes and output description.

In one embodiment, a server invokes an image-generative AI model that implements a diffusion-based architecture. The image-generative AI model includes a text encoder (for example, an encoder based on a transformer architecture), a U-Net-type denoising network, and a variational autoencoder (VAE) decoder. A server converts the prompt sentence into tokens using a tokenizer, embeds the tokens using an embedding matrix, and feeds the token sequence to the text encoder to obtain a text embedding vector. A server supplies the text embedding to the U-Net denoising network together with a latent noise tensor and iteratively reduces noise through a predetermined number of time steps using a sampling scheduler. After the denoising process, a server applies the VAE decoder to generate an image tensor, converts the tensor to a standard image format such as PNG using an image processing library, and stores and transmits the resulting image to a terminal.

A server reduces processing latency by maintaining the image-generative model and associated weights in memory across multiple generation requests, by caching tokenization results for frequently used prompt segments, and by adjusting inference parameters such as the number of denoising steps and classifier-free guidance scale based on network load and user preferences. Because a server generates images on demand instead of transmitting large catalogs of predefined assets, a server reduces network bandwidth consumption and storage redundancy, thereby improving technical performance of the overall system.

In another embodiment, a server uses a voice-generative AI model to synthesize speech for the virtual object. The voice-generative AI model includes a sequence-to-sequence component that converts text into an acoustic representation (such as a mel-spectrogram) and a vocoder component that converts the acoustic representation into a waveform. The sequence-to-sequence component uses attention mechanisms to align text tokens with time frames, and the vocoder may use a convolutional neural network or a flow-based model. A server supplies, as input to the voice-generative model, a text script representing what the avatar will say, and voice characteristic information specifying parameters such as base timbre identifier, pitch offset, and emotional tone. A server also controls speaking-style characteristic information depending on an estimated emotional state, for example, by setting a slower speaking rate and softer intensity when the emotional state indicates sadness.

A server generates prompt sentences for the voice-generative model that describe target voice style, for example:

“Generate a calm, gentle voice with a slightly soft tone, speaking the following line in a supportive manner: ‘I'm here with you. Let's take things one step at a time.’”

By encoding voice control information in prompt sentences and auxiliary control vectors, a server guides the generative model to produce consistent and individualized voice outputs. This leads to reduced need for separate manual voice design per user and improves computational efficiency by unifying control logic through a prompt-based interface.

A server performs emotion estimation on dialog data received from a terminal. A terminal transmits user messages including character information and symbol information (such as emoji) to a server. A server preprocesses text by tokenization, lower-casing, and removal or transformation of certain functional tokens. A server maps symbol information to emotion feature vectors using a predefined dictionary that associates each symbol with one or more emotional dimensions (for example, valence, arousal, dominance). A server concatenates text features and symbol features into a combined feature vector and inputs this vector into an emotion estimation model.

In one embodiment, the emotion estimation model comprises a text encoder based on a bidirectional transformer and a classification head. The classification head outputs probability scores over several emotional states such as joy, sadness, anger, and calmness. A server computes a loss function during training that combines cross-entropy over emotion labels with a regularization term enforcing temporal smoothness across dialog turns. By training the model on large-scale dialog datasets with labeled emotions and symbol usage, a server obtains an emotion estimator that can more accurately interpret subtle user states than simple rule-based sentiment analyzers. This contributes to improved selection of response strategies and better stability of user interaction.

A server further uses a dialog management module to maintain conversation history for each user session. The conversation history includes previous user messages, previous system responses, estimated emotional states, and metadata such as time stamps and context tags. A server uses this history to adjust prompt sentences dynamically. For example, when recent estimated emotional states indicate continuous stress or sadness, a server modifies prompt sentences for a generative-text model to enforce a more supportive and concise style, using instructions such as: “Respond briefly and gently. The user has been feeling stressed for several messages. Avoid giving medical advice and instead suggest small, manageable actions.”

By feeding such prompt sentences, together with structured history, to a generative-text model, a server ensures that generated responses are adapted to long-term context, rather than merely reacting to single messages. This reduces abrupt changes in system behavior and improves coherence, which technically manifests as more predictable and stable state transitions in the dialog management process.

A server integrates the image, voice, and dialog subsystems through a prompt-centric orchestration layer. In this layer, a server internally represents control directives for different generative AI models as prompt sentences and structured control vectors. A server stores prompt templates for common tasks, such as avatar creation, avatar modification, supportive response generation, and voice style selection, and fills these templates with current attribute information, emotional state, and conversation context. Because prompt construction and model invocation are centralized, a server can optimize reuse of intermediate results, such as text embeddings, across multiple models, and can schedule inferencing on available hardware resources (CPUs and GPUs) to balance load and reduce latency.

A server improves computational efficiency relative to naive designs where each client directly composes prompts and invokes models independently. A server reduces duplication of work by caching frequently used prompt segments and pre-computing certain embeddings. A server also compresses and transmits only generated outputs (images and audio) instead of transferring intermediate model states or large libraries of static assets. This reduces communication load between the server and terminals, which is a technical advantage particularly in bandwidth-constrained environments such as mobile networks.

A terminal receives generated image data and uses a graphics engine to map the image as a texture onto a two-dimensional or three-dimensional avatar representation. A terminal maintains a local scene graph representing objects in a virtual space, and updates the avatar node when new image data is provided. A terminal also controls an animation subsystem to trigger facial expressions or body movements synchronized with voice playback. For example, when a server indicates that an audio clip corresponds to a specific emotional tone and duration, a terminal uses pre-defined mapping tables to select a mouth movement pattern and head motion, thereby achieving synchronized, low-latency visual feedback without requiring high-bandwidth streaming of fine-grained animation data.

A user interacts with the avatar in the virtual space by changing attribute information, sending messages, and responding to the avatar's speech and appearance. A user can, for example, change hair color or clothing style in a settings interface. Upon such change, a terminal sends updated attribute information to a server. A server converts the updated attributes into a new or amended prompt sentence such as:

“Modify the existing avatar to have red hair, green eyes, a slim body type, and round glasses, keeping the same facial structure and clothing style, in the same visual style as the current avatar.”

Because the prompt sentence explicitly indicates preservation of certain elements, the generative image model can produce outputs that are visually consistent across updates. This consistency reduces cognitive load on the user and avoids the need for manual re-tuning of avatars after each update.

A server implements learning and updating mechanisms for the models used in the system. During a training phase, a server performs supervised learning and fine-tuning on the image-generative model, the voice-generative model, the prompt-mapping model, and the emotion-estimation model using training datasets stored in an offline storage device. A server uses gradient-based optimization (for example, stochastic gradient descent or an adaptive optimizer) to update model parameters. For each model, a server defines specific loss functions, such as reconstruction loss and perceptual loss for image generation, sequence-level loss for text-to-speech alignment, and classification loss for emotion estimation. A server may apply data augmentation techniques, such as color jittering and random cropping for image data, and text paraphrasing and symbol augmentation for dialog data, to improve robustness and generalization.

By designing these models and training them in a coordinated manner, a server obtains generative functions that can handle the heterogeneous inputs and outputs required by the system. Importantly, these models process data according to mathematically defined optimization objectives and algorithmic rules that are not simply automated replicas of manual human behavior. For example, the diffusion process in image generation uses iterative denoising in a high-dimensional latent space, which has no direct analogue in human asset creation workflows. This contributes to technical improvements in generation speed and diversity of outputs compared with pre-rendered asset approaches.

In another embodiment, a server uses an alternative type of generative AI model, such as an autoregressive image model or a generative adversarial network, instead of or in combination with a diffusion-based model. A server also may use different text encoders or multimodal encoders that jointly process text and symbolic features. Similarly, a server may replace the voice-generative model with a different neural vocoder architecture while maintaining the same prompt-centric orchestration structure. In each such variation, a server maintains the key functionality of converting attribute information and dialog context into prompt sentences and using those sentences to control generative processing.

A server, a terminal, and a user thus cooperate to implement the described embodiments. A server executes specific hardware-accelerated operations for neural network inference and training, manages data structures for attributes, conversation history, and prompts, and orchestrates multiple generative AI models through a unified prompt-centric layer. A terminal renders and plays generated content while minimizing bandwidth and latency, and a user interacts with the system in real time to personalize and refine avatars. Because the described processing architecture improves how a computer system manages, generates, and synchronizes multimodal data, the system provides technical benefits such as reduced network load, lower response time, improved personalization accuracy, and consistent multimodal output, beyond mere automation of human creative tasks.

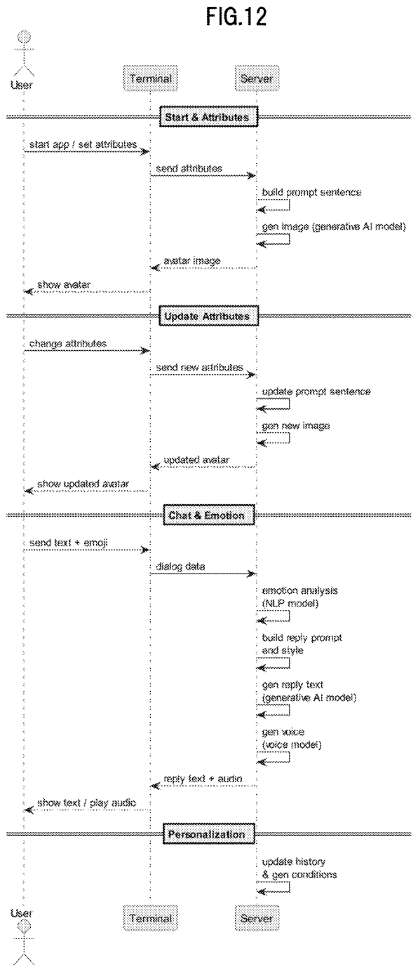

The following describes the processing flow using FIG. 12.

### Step 1:

User operates the terminal to start the avatar customization application.

User provides initial inputs such as selecting a “Create avatar” menu, choosing a language, and optionally logging in.

Terminal displays an initial user interface that includes controls for specifying attribute information (for example, hair color, eye color, body type, clothing style) and a chat window.

Input: user touch or click events and text input.

Output: user interface state data on the terminal and a session start request sent from the terminal to the server.

Terminal sends a session initialization request including a device identifier and optional user identifier to the server.

Server receives the request, generates a session ID, allocates memory structures for attribute information and conversation history, and stores the session ID and associated metadata in a database.

### Step 2:

User specifies attribute information for a virtual object through the terminal.

User selects options such as hair color, eye color, body type, and clothing style using buttons, sliders, or dropdown menus.

Terminal captures each selection event, updates a local attribute data structure, and displays a provisional preview (for example, color swatches and generic outlines).

Input: user selection events for each attribute.

Output: a structured attribute record maintained on the terminal and a formatted attribute message to be sent to the server.

Terminal constructs a message including attribute names and values (for example, “hair color=blue”, “eye color=green”, “body type=slim”, “clothing style=casual”) and sends this message to the server via a network request.

### Step 3:

Server receives the attribute message from the terminal.

Server parses the message into an internal attribute vector and validates each field against predefined schemas (for example, checking allowed color values or style categories).

Input: attribute message from the terminal.

Output: a normalized attribute vector stored in server memory and a set of high-level semantic tags derived from the attributes.

Server converts the normalized attribute vector into higher-level semantic tags using rule-based mappings and optionally a learned mapping model.

Server then concatenates the semantic tags into a natural language description and generates a prompt sentence for a generative AI model, for example:

“Generate an avatar with blue hair, green eyes, and a slim body type, wearing casual clothing, in a clean anime style, full-body portrait.”

Server stores the generated prompt sentence together with the attribute vector and the session ID in the database.

### Step 4:

Server invokes an image generative AI model based on the generated prompt sentence.

Server tokenizes the prompt sentence into text tokens, embeds the tokens using an embedding matrix, and encodes the sequence with a text encoder to obtain a text embedding vector.

Input: prompt sentence describing the virtual object.

Output: a text embedding vector and, after further processing, an image tensor representing the virtual object.

Server initializes a latent noise tensor and executes a diffusion-based denoising process using a U-Net network conditioned on the text embedding.

Server iteratively updates the latent tensor across multiple time steps according to a scheduler algorithm, reducing random noise while aligning the latent representation with the semantic content of the prompt sentence.

Server applies a decoder (for example, a variational autoencoder decoder) to convert the final latent tensor into an image tensor, then converts that tensor into an image file (for example, a PNG) using an image processing library.

### Step 5:

Server prepares the generated image data for transmission to the terminal.

Server may resize the image, adjust color space, or compress the image to reduce file size while preserving quality.

Input: image tensor or image file generated by the generative AI model.

Output: a formatted image file or binary stream and a response message containing a reference to the image.

Server stores a reference to the image in a storage system and associates it with the session ID.

Server constructs a response message including an image URL or an image binary payload and sends the response to the terminal over the network.

### Step 6:

Terminal receives the image response from the server.

Terminal decodes the image data using its operating system's image APIs and loads the image into GPU memory via a graphics engine.

Input: image URL or binary image data from the server.

Output: a rendered avatar image presented on the terminal's display.

Terminal updates the avatar display area in the user interface, replacing any placeholder with the generated avatar.

User visually inspects the avatar and determines whether the appearance matches the desired attributes.

### Step 7:

User modifies attribute information to refine the avatar.

User changes one or more attribute values, for example changing hair color from blue to red or adding glasses.

Terminal captures the change, updates the local attribute record, and computes a delta or updated attribute set.

Input: user actions updating attribute controls.

Output: an updated attribute message sent to the server that reflects the changes.

Terminal sends the updated attributes to the server through another network request, including the session ID.

Step 8: Server receives the updated attribute information.

Server merges the updated attributes with the previously stored attribute vector, ensuring consistency and resolving conflicts.

Input: updated attribute message from the terminal and existing attribute vector from the database.

Output: a new, consolidated attribute vector and a revised prompt sentence.

Server regenerates a prompt sentence that reflects the updated attributes while optionally preserving aspects of the previous style, for example:

“Modify the existing avatar to have red hair, green eyes, a slim body type, and round glasses, keeping the same facial structure and casual clothing, in the same visual style as the current avatar.”

Server inputs the revised prompt sentence to the image generative AI model, repeats the tokenization, embedding, and denoising process, and generates an updated image.

Server transmits the updated image to the terminal, which then updates the avatar display accordingly.

### Step 9:

User initiates dialog with the avatar through the terminal.

User enters a text message and optionally selects one or more emojis in a chat interface, for example: “I feel tired today [symbol] ”.

Terminal packages the text string and associated emojis as dialog data.

Input: user chat message and selected emojis.

Output: a dialog message object transmitted to the server.

Terminal appends the message to the local chat history display and sends the dialog message to the server identified by the session ID.

### Step 10:

Server receives the dialog message and performs emotion estimation.

Server splits the message into character information and symbol information, tokenizes the text, and maps each emoji to an emotion vector using a predefined dictionary.

Input: dialog message consisting of text and emojis.

Output: an emotion feature vector and an estimated emotional state classification.

Server feeds the text tokens into a natural language processing model, such as a transformer-based encoder, and obtains a text feature vector.

Server concatenates the text feature vector with the emoji emotion vectors and provides this combined feature vector to an emotion estimation model, which outputs probability scores over different emotional states.

Server selects the emotional state with the highest probability and stores the result, together with the dialog message, as part of the conversation history for the session.

### Step 11:

Server generates a response content specification based on the estimated emotional state and the avatar attributes.

Server retrieves recent conversation history and the current virtual object attributes from the database.

Input: emotional state estimate, conversation history, and attribute vector.

Output: a response specification including target tone, length, and content constraints.

Server constructs a prompt sentence for a generative text model, for example:

“You are a supportive virtual avatar with a casual, friendly style. The user feels tired and sad. Respond briefly and gently, offering encouragement without medical advice.”

Server passes this prompt sentence and the last user message to the generative text model, which outputs a response text such as: “I'm sorry you're feeling so worn out. It's okay to slow down today-let's take things one step at a time.”

Server may then create a secondary prompt sentence for the voice generation model:

“Generate a calm, gentle voice with a slightly soft tone, speaking the following line in a supportive manner: ‘I'm sorry you're feeling so worn out. It's okay to slow down today-let's take things one step at a time.’”

### Step 12:

Server invokes the voice generative AI model using the voice prompt and voice characteristic information.

Server converts the response text into phonetic units and feeds them, along with voice characteristic parameters, into a sequence-to-sequence acoustic model.

Input: response text, voice characteristic information, and a voice-style prompt sentence.

Output: a waveform or encoded voice data configured as the avatar's speech.

Server obtains a mel-spectrogram from the acoustic model and passes it to a vocoder network, which outputs a digital audio waveform.

Server optionally normalizes the audio volume, encodes the waveform into a compressed audio format, and stores a reference in the database.

Server sends the response text and the audio data to the terminal as part of a dialog response message.

### Step 13:

Terminal receives the dialog response message from the server.

Terminal displays the response text as a chat bubble near the avatar and loads the audio data into a media playback subsystem.

Input: response text and encoded audio data from the server.

Output: visual chat content on the display and audible speech from the avatar.

Terminal plays the audio through the audio output device and may trigger associated avatar animations, such as mouth movement and head nodding, using a mapping table between audio duration/emotional tone and animation patterns.

User reads the text and listens to the avatar's speech, and may respond with further messages or adjust avatar attributes, thereby repeating earlier steps.

### Step 14:

Server continuously updates generation conditions and prompt construction rules based on accumulated conversation history.

Server periodically analyzes the stored emotional states, the frequency of certain attribute changes, and patterns in user engagement.

Input: conversation history records, emotional state logs, and avatar configuration changes.

Output: updated parameters for prompt templates, model hyperparameters, and personalization settings for the user.

Server adjusts parameters such as default tone, verbosity, and preferred visual style in prompt sentences used for future image, text, and voice generation.

Server also updates internal weights of personalization modules (for example, preference models) using machine learning techniques, thereby refining the mapping from user behavior to generation conditions.

As a result, the generative AI models are invoked with progressively better-tailored prompt sentences, improving accuracy, consistency, and responsiveness in subsequent interactions.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional systems that use generative artificial intelligence models to create virtual content and synthesized speech often require end users to specify low-level model parameters or expert-only configuration options. In particular, in voice generation for virtual objects or characters, a user is typically required to adjust hardware- or algorithm-oriented parameters, such as acoustic model settings, prosody control variables, or vocoder options. This complexity burdens the user with technical details that are unrelated to the user's actual intent regarding pitch, speaking speed, speaking style, or emotional tone. As a result, the user frequently obtains speech output that does not match the intended characteristics, and must iteratively repeat trial-and-error adjustments, leading to inefficient use of computing resources and degraded user experience.

Further, known systems for emotional support messaging often analyze text or symbols in a chat interface and generate canned responses or rule-based messages. Such systems do not tightly integrate emotion estimation results with generative artificial intelligence models in a way that consistently produces messages and voices that align with a detected emotional state. In particular, existing architectures do not provide a unified processing flow in which user-specified attributes, chat-derived emotion signals, and voice parameters are normalized into structured prompt sentences that can be consumed by various generative artificial intelligence models in a consistent manner.

Additionally, in many architectures, client devices and servers merely pass through text or parameter values to a backend model endpoint without performing systematic transformation of user-level parameters into machine-targeted instructions. This pass-through design can result in inconsistent prompts, model misinterpretation, and wasted computation cycles on the generative artificial intelligence models, since the models receive inputs that are not well-aligned with their training distributions or expected instruction format.

Accordingly, there is a need for an improved computer-based system and processing method that (i) allows a user to specify intuitive, high-level voice characteristics and attribute information, (ii) automatically translates such information into consistent, structured prompt sentences suitable for different generative artificial intelligence models, (iii) integrates chat-based emotion estimation into both text generation and voice generation, and (iv) improves the overall efficiency, reliability, and quality of virtual object generation and voice generation in a networked environment.

The specific processing by the specific processing unit 290 of the data processing device 12 in Example 2 is realized by the following means.

The present invention provides a server comprising a processor configured to receive, from a terminal operated by a user, input information indicating voice characteristics including at least a pitch, a speaking speed, and a speaking style as numerical or symbolic values for voice generation, and to store the input information in an internal data structure; to analyze the numerical or symbolic values for voice generation received from the terminal and convert the numerical or symbolic values into a natural language description by using character string processing to generate, as a prompt sentence, a voice generation instruction sentence to be input to a generative artificial intelligence model; to input, via a communication network, a request including the voice generation instruction sentence to a generative artificial intelligence model for voice generation and obtain voice data based on a voice waveform generation process performed by the generative artificial intelligence model; to encode the obtained voice data into a predetermined audio file format, to transmit the encoded voice data to the terminal, and to cause the terminal to present the encoded voice data to the user; to receive attribute information specified by the user as input information and generate, as a prompt sentence, an instruction sentence that instructs a generative artificial intelligence model to generate a virtual object based on the attribute information; to analyze text information and symbol information received in a dialog format, estimate an emotional state of the user by using natural language processing, generate, as a prompt sentence, an instruction sentence that instructs a generative artificial intelligence model to generate a reassurance message based on a result of the estimation, and cause the reassurance message generated by the generative artificial intelligence model to be presented to the user via the terminal; and, in some embodiments, to use a generative artificial intelligence model for image generation to generate image data of the virtual object based on the attribute information of the user, and to add, to the voice generation instruction sentence, information indicating an emotional state corresponding to the result of the estimation of the emotional state of the user so as to instruct the generative artificial intelligence model to generate voice data reflecting the emotional state. This enables an improvement of computer technology in that the server-side processor systematically transforms high-level, user-friendly input parameters and emotion signals into optimized prompt sentences for multiple generative artificial intelligence models, thereby reducing mismatches between user intent and generated outputs, lowering the need for repeated inference cycles, and increasing the consistency, efficiency, and quality of both text-based reassurance messages and synthesized voices generated across a distributed networked environment.

The term “system” refers to a combination of hardware and software components including at least one processor, memory, and communication interface, configured to execute one or more programs to perform the functions described in the claims.

The term “processor” refers to one or more hardware processing units, such as a central processing unit or a graphics processing unit, capable of executing machine-readable instructions to perform data processing operations.

The term “terminal” refers to an information processing device operated by a user, such as a personal computer, a mobile device, or another computing device, that can transmit input information to and receive output information from the server via a communication network.

The term “user” refers to a human operator who interacts with the terminal to input information, request generation of content, and receive and perceive outputs provided by the system.

The term “input information” refers to digital data received from the terminal and representing user selections or entries, including but not limited to voice characteristics, attribute information, and text or symbol data.

The term “voice characteristics” refers to properties of a desired synthesized voice, including at least pitch, speaking speed, and speaking style, and optionally additional attributes such as emotional tone or speaker type.

The term “pitch” refers to a parameter representing the perceived fundamental frequency level of a voice, expressed as a relative or absolute value that influences how high or low the voice sounds.

The term “speaking speed” refers to a parameter representing the rate at which speech is produced over time, expressed as a relative or absolute measure that influences how fast or slow the voice is perceived.

The term “speaking style” refers to a parameter representing a qualitative manner of speech, including at least dialect, accent, formality, or other stylistic features that characterize how the voice is expressed.

The term “numerical or symbolic values for voice generation” refers to parameter values for voice characteristics that are represented as numbers, codes, labels, or other discrete symbols suitable for programmatic processing.

The term “internal data structure” refers to an organized representation of data stored in memory by the processor, such as a record, list, map, object, or other structured format that allows access and manipulation of the stored information.

The term “character string processing” refers to operations performed on text data, including concatenation, formatting, normalization, substitution, or other manipulations used to construct or transform textual expressions.

The term “natural language description” refers to a human-readable textual expression in a natural language that semantically represents one or more voice characteristics, attribute values, or other user-related information.

The term “prompt sentence” refers to a natural language description or instruction text formatted as a sentence or sentence-like expression, which is supplied as input to a generative artificial intelligence model to guide content generation.

The term “voice generation instruction sentence” refers to a prompt sentence that explicitly or implicitly specifies desired characteristics of synthesized speech and is used to instruct a generative artificial intelligence model to generate voice data.

The term “generative artificial intelligence model” refers to a machine-learned model configured to generate output data, such as image data, text data, or audio data, based on input data including prompt sentences and control parameters.

The term “generative artificial intelligence model for voice generation” refers to a generative artificial intelligence model specialized to produce voice data or speech waveforms based on textual or symbolic input, including prompt sentences.

The term “communication network” refers to a wired or wireless communication infrastructure that enables data exchange between the terminal and the server, and between the server and external or internal generative artificial intelligence models.

The term “voice data” refers to digital audio information representing speech or a voice signal, including raw waveform samples or encoded audio formats suitable for storage, transmission, and playback.

The term “voice waveform generation process” refers to a sequence of computational operations performed by a generative artificial intelligence model or associated components to produce digital voice data from input instructions, including at least feature generation and waveform synthesis.

The term “predetermined audio file format” refers to a standardized digital audio encoding format, such as a waveform audio format or compressed audio format, that is specified in advance for representing the generated voice data.

The term “attribute information” refers to user-related or content-related properties, such as age group, gender, personality, style preferences, or other characteristics, which are used as input to control generation of a virtual object or other content.

The term “virtual object” refers to a digital entity, such as a virtual character, avatar, or graphical representation, that is generated by a generative artificial intelligence model based on attribute information or other inputs.

The term “text information” refers to alphanumeric characters and other textual symbols that are exchanged in a dialog format between the user and the system, and that are used as input for natural language processing.

The term “symbol information” refers to non-alphabetic visual or textual elements, such as pictograms, emoticons, or other symbolic markers, that are exchanged in a dialog format and used as input for emotion estimation.

The term “dialog format” refers to an interaction pattern in which the user and the system exchange sequences of text information and symbol information in a conversational manner, such as chat-style communication.

The term “natural language processing” refers to computational techniques that analyze, interpret, and manipulate natural language text or symbols to derive semantic, syntactic, or pragmatic information, including estimation of an emotional state.

The term “emotional state” refers to a representation of a user's affective condition, such as calm, anxious, happy, sad, or similar categories or continuous values, that is inferred from text information, symbol information, or other signals.

The term “reassurance message” refers to a textual or textual-like expression generated to provide comfort, support, or encouragement to the user in accordance with the estimated emotional state.

The term “image data of the virtual object” refers to digital image information, such as bitmap or vector data, representing a visual appearance of the virtual object generated by a generative artificial intelligence model for image generation.

The term “generative artificial intelligence model for image generation” refers to a generative artificial intelligence model configured to produce image data based on input attribute information, prompt sentences, or other control data.

The term “information indicating an emotional state” refers to metadata or content elements, such as labels, descriptors, or embedded instructions, that encode a desired emotional tone or affect for use in voice generation.

The term “voice data reflecting the emotional state” refers to synthesized voice data whose acoustic and prosodic properties, such as intonation, rhythm, and energy, are adjusted to express or correspond to a particular emotional state.

In one embodiment, a server cooperates with one or more terminals operated by users to implement the claimed system. The server comprises at least one processor, a main memory, a non-volatile storage device, and a network interface. The terminal comprises at least one processor, a main memory, a display device, an audio output device, an input interface, and a network interface. The server and the terminal communicate via a wired or wireless communication network using standard communication protocols.

The terminal executes an application program, such as a native mobile application or a web application running in a browser, which presents a graphical user interface to the user. The user operates the terminal to specify voice characteristics, attribute information for a virtual object, and dialog content. The terminal transmits structured digital data representing such user input to the server. The server executes server-side programs stored in the non-volatile storage device to perform the data processing operations described below.

The server uses general-purpose computing hardware, such as a central processing unit and optionally a graphics processing unit, to execute software modules implemented using common software frameworks. For example, the server can use a web application framework to implement an application programming interface, a numerical computation framework to execute a neural network inference engine, and an audio processing library to encode and decode audio data. The server can also be connected to one or more accelerator devices, such as graphics processing units, to execute neural network computations for a generative AI model.

In one configuration, the terminal receives, via the input interface, user selections of voice characteristics including pitch, speaking speed, and speaking style. The terminal represents each selection as a symbolic value, such as a string label or an integer code. The terminal aggregates these values into a structured data object stored in the main memory of the terminal. The terminal then transmits this object to the server in a request message.

The server receives the request message and parses the structured data into an internal data structure. The server stores this structure in main memory as an in-memory object comprising key-value pairs, where keys correspond to the types of voice characteristics and values correspond to the user selections. The server converts the user-level parameters into a prompt sentence that is suitable as input to a generative AI model for voice generation.

The server uses a specialized text construction module to transform the internal data structure into a natural language description. This module applies deterministic rules and templates that map discrete parameter values to descriptive phrases. For example, when the internal data structure indicates pitch=“high,” speaking speed=“fast,” and speaking style=“Kansai dialect,” the server generates a prompt sentence such as:
“Generate a high-pitched, fast-speaking Japanese voice in Kansai dialect with a friendly tone.”

The server can generate alternative prompt sentences for different combinations of parameters, such as:
“Generate a calm, low-pitched male voice speaking slowly in standard Japanese.”
“Generate a bright, medium-pitched female voice speaking at normal speed in standard Japanese with a cheerful tone.”
“Generate a clear, neutral narrator voice with moderate pitch and speed, without any regional accent.”

The server thereby normalizes user-level input into a machine-targeted prompt sentence that is consistent with the expected input distribution of the generative AI model. This transformation is not a mere pass-through of user text, but a structured encoding of discrete parameters into textual features designed for improved model performance.

The server then provides the generated prompt sentence as input to a generative AI model for voice generation. In one embodiment, the generative AI model is implemented as a sequence-to-sequence neural network comprising a text encoder and an audio decoder. The text encoder can be implemented as a transformer network with multiple layers of self-attention and feedforward sublayers. The audio decoder can be implemented as a neural vocoder, such as a convolutional or autoregressive model, which converts intermediate acoustic representations into time-domain waveforms.

The server converts the prompt sentence into a sequence of tokens using a tokenizer. The tokens are mapped to numerical vectors via an embedding layer. The transformer encoder computes contextualized representations by applying multi-head self-attention and non-linear transformations. The encoder output is then transformed into an intermediate acoustic representation, such as a mel-spectrogram. The neural vocoder receives this representation and performs a series of convolutional, upsampling, and non-linear activation operations to generate a sequence of audio samples.

The server stores the generated waveform as an array of numerical values in main memory. The server then uses an audio processing library to encode the waveform into a predetermined audio file format such as WAV or a compressed format such as MP3. The server sets encoding parameters such as sample rate, bit depth, and number of channels. The server may apply signal processing operations, such as normalization and trimming, to reduce clipping and unnecessary silence.

The server transmits the encoded voice data to the terminal over the communication network.

The terminal receives the encoded data and stores it in main memory or secondary storage. The terminal decodes the audio file using an audio playback library and sends the audio signal to the audio output device, such as a speaker or headphones. The user listens to the generated voice and assesses whether the output matches the desired voice characteristics.

The server also receives attribute information for a virtual object from the terminal. The attribute information can include high-level properties such as age category, personality description, preferred color scheme, or style. The server stores this attribute information in a structured data object and maps individual attributes to descriptive phrases. The server then generates a prompt sentence for a generative AI model for image generation. For example, the server can generate a prompt sentence such as:
“Generate a friendly, youthful virtual character with medium-length hair and a casual outfit.”

The server transmits this prompt sentence to a generative AI model for image generation. The model can be implemented as a diffusion model or a generative adversarial network that accepts textual conditioning. The server receives the generated image data as a numerical tensor representing pixel values and encodes it into an image file format such as PNG or JPEG. The server sends the image file to the terminal, and the terminal displays the image on the display device for the user.

In addition, the server processes dialog input received in a chat-like format from the terminal. The terminal displays a chat interface where the user enters text messages and selects or uses symbol information such as emoticons. The terminal transmits the text information and symbol information as structured digital data to the server. The server stores the dialog content as a sequence of messages, where each message includes text content, symbol content, timestamps, and user identifiers.

The server uses a natural language processing module to estimate an emotional state of the user based on the dialog content. In one embodiment, the server implements a neural network classifier that receives text tokens and symbol embeddings as input. Text tokens are obtained by applying a tokenizer to the user's messages, and symbol information is converted to numeric representations through a learned embedding table. The model architecture can be based on a transformer encoder or a bidirectional recurrent network combined with an attention mechanism. The server trains this emotional state classifier using supervised learning. During training, the server accesses labeled dialog samples stored in a training data repository. Each sample includes dialog text, symbol sequences, and corresponding emotional state labels such as “calm,” “anxious,” or “sad.” The server computes a loss function, such as cross-entropy loss, between the predicted emotional state distribution and the ground-truth labels. The server updates the network parameters using gradient-based optimization, such as stochastic gradient descent or an adaptive learning rate method. The server may apply regularization and data augmentation techniques, such as random symbol masking or sentence shuffling, to improve generalization. During inference, the server applies the trained classifier to the incoming dialog content. The classifier outputs a probability distribution over possible emotional states. The server selects an emotional state with the highest probability or applies threshold-based rules to select an appropriate state. The server then constructs a prompt sentence for a generative AI model to generate a reassurance message aligned with the estimated emotional state.

The server uses a prompt construction module that considers both the emotional state and recent dialog content. For a user estimated to be anxious, the server can generate a prompt sentence such as:
“Generate a gentle, reassuring message to comfort a user who is feeling anxious about their current situation.”

For a user estimated to be sad, the server can generate a prompt sentence such as:
“Generate a warm and supportive message that acknowledges the user's sadness and encourages them with empathy.”

The server transmits the prompt sentence to a generative AI model for text generation, implemented as a language model with a transformer architecture. The language model processes the prompt sentence and produces a reassurance message as a sequence of text tokens. The server decodes these tokens into characters and sends the reassurance message to the terminal. The terminal displays the reassurance message in the chat interface.

In some embodiments, the server uses the emotional state estimation to modify the voice generation process as well. The server adds emotional state information to the voice generation instruction sentence. For instance, when the emotional state is estimated as “anxious,” the server generates a prompt sentence such as:
“Generate a calm, soft-spoken voice with slow speed and a gentle tone to reassure a user who is feeling anxious.”

The server then uses this prompt sentence as input to the generative AI model for voice generation. The resulting voice data has prosodic patterns that reflect the emotional state, such as slower speaking rate and softer intonation for calming effects. Because the emotional state is encoded in a structured manner in the prompt sentence and processed by a neural architecture optimized for such inputs, the generated voice more reliably matches the intended affective tone. By transforming discrete user parameters and emotion estimations into structured prompt sentences, the server achieves technical improvements in model alignment and inference efficiency. The normalization of user inputs into consistent text templates reduces variance in model inputs and leads to more stable and predictable outputs. This reduces the number of repeated inference cycles required for the user to obtain an acceptable voice or reassurance message, thereby lowering computational load on the generative AI models and reducing network traffic between the server and the terminal.

Furthermore, the server implements a specific data flow and module configuration that improves data management and computation efficiency. The server maintains separate but interconnected data structures for voice parameters, attribute information, dialog history, and emotional states. Each data structure is optimized for its purpose: for example, key-value maps for fast access to voice parameters, sequence structures for chronological dialog messages, and probability vectors for emotional state estimates. The server's modules—parameter parsing, prompt generation, emotion classification, generative model inference, and encoding/decoding—are connected in a pipeline that minimizes redundant conversions and memory copies.

The server can cache intermediate representations, such as tokenized prompt sentences or encoder outputs, for repeated use when the user modifies only a subset of parameters. This caching strategy reduces total processing time and energy consumption, representing a concrete improvement in computer performance. The combination of caching and structured prompt generation also reduces latency perceived by the user, improving the responsiveness of the system.

In alternative embodiments, the server can employ different neural network architectures for the generative AI models, such as diffusion-based models for speech or images, or hybrid architectures combining convolutional and recurrent layers. The server can also adapt the prompt construction rules based on observed model performance, by logging model outputs and associated user satisfaction indicators and using this data to refine templates and mappings. Such adaptation can be performed offline and then deployed as updated prompt generation rules.

The terminal and the server cooperate in a way that goes beyond mere automation of human mental steps. The terminal collects user-friendly high-level inputs, while the server performs complex transformations, neural computations, and optimization-driven inference that cannot be executed reliably by a human. The specific interaction between discrete parameter encoding, neural model architecture, and audio/image encoding results in measurable improvements in speed, accuracy, and resource utilization when compared to systems that directly expose low-level model controls to users or pass through arbitrary text without structured normalization. Because the server consistently converts heterogeneous user inputs and emotional signals into unified prompt sentences designed for particular generative AI models, the system reduces misalignment between user intent and model behavior. This reduction in misalignment directly lowers the rate of failed or unsatisfactory generations, which in turn decreases the frequency of repeated requests and associated computation and communication. As a result, the system improves the technical functioning of the computer system as a whole, including the server and the terminal, by reducing processing load, network bandwidth usage, and latency, and by increasing the precision and reliability of generated voice and text outputs.

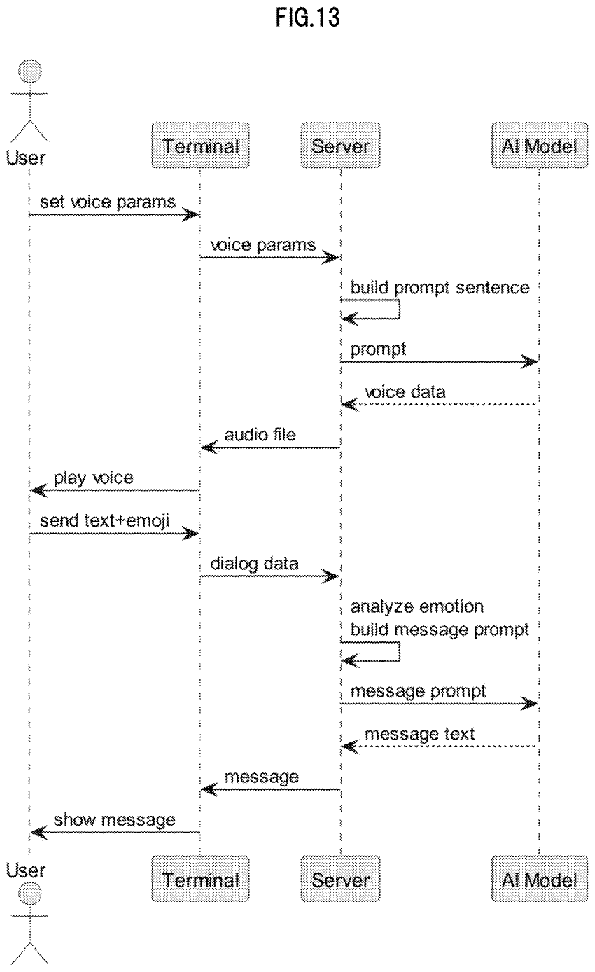

The following describes the processing flow using FIG. 13.

### Step 1:

The user operates the terminal to input voice characteristics.

The user views a graphical user interface on the terminal, selects values for pitch, speaking speed, and speaking style from controls such as drop-down lists and sliders, and optionally inputs additional conditions such as emotional tone. As input, the terminal receives discrete selections (for example, “high,” “fast,” “Kansai dialect,” “friendly”). As output, the terminal stores these selections as an internal structured object in memory, for example a set of key-value pairs like {pitch: “high”, speed: “fast”, style: “Kansai dialect”, emotion: “friendly”}.

### Step 2:

The terminal converts the user selections into symbolic parameter data.

The terminal reads the stored key-value pairs and normalizes each value to a canonical symbolic representation (for example, mapping localized labels to standard codes). As input, the terminal uses raw UI values and a predefined parameter table. As output, the terminal produces normalized symbolic data, such as {pitch_code: P3, speed_code: S3, style_code: A2, emotion_code: E1}, by performing table lookup operations and type checks.

### Step 3:

The terminal transmits the symbolic parameter data to the server.

The terminal serializes the normalized parameter data into a request message, attaches metadata (such as a user identifier and a request identifier), and sends the message via a network interface to the server. As input, the terminal uses the normalized symbolic data and connection settings. As output, the terminal generates and transmits a network packet containing the structured parameter data to the server, and then waits for a response.

### Step 4:

The server receives the parameter data and constructs an internal data structure.

The server accepts the network packet through a communication interface, parses the message body, and reconstructs the symbolic parameter data into an in-memory object. As input, the server uses the serialized request payload from the terminal. As output, the server creates an internal data structure, such as a map or record, that holds the voice-related codes and associated metadata, ready for further processing.

### Step 5:

The server maps symbolic parameters to descriptive phrases.

The server uses a rule set or template table to map each code in the internal data structure to a corresponding natural language phrase. As input, the server uses the symbolic parameter object {pitch_code, speed_code, style_code, emotion_code} and a phrase mapping table stored in non-volatile memory. As output, the server generates phrase fragments, such as “high-pitched,” “fast-speaking,” “in Kansai dialect,” and “with a friendly tone,” by performing table lookups and concatenation of static phrase elements.

### Step 6:

The server generates a voice generation prompt sentence.

The server combines the phrase fragments into a grammatically coherent prompt sentence using a text construction algorithm that applies ordering rules and punctuation rules. As input, the server uses the list of phrase fragments and a sentence template (for example, “Generate a [pitch], [speed] [language] voice [style] [emotion].”). As output, the server produces a single prompt sentence string, such as “Generate a high-pitched, fast-speaking Japanese voice in Kansai dialect with a friendly tone.”, by inserting the phrase fragments into the template and applying string concatenation and formatting operations.

### Step 7:

The server tokenizes the prompt sentence and prepares model input.

The server applies a tokenizer associated with the generative AI model to convert the prompt sentence into a sequence of discrete tokens, and then converts tokens into numerical IDs and embeddings. As input, the server uses the prompt sentence string and a tokenizer configuration. As output, the server obtains a numerical input representation, such as an array of token IDs and a matrix of embedding vectors, by performing text segmentation, dictionary lookup, and vector multiplication.

### Step 8:

The server performs neural inference with the generative AI model for voice generation.

The server feeds the numerical input representation into a generative AI model implemented as a neural network, such as a transformer-based text encoder coupled with a neural vocoder. As input, the server uses the token embeddings and internal model parameters (weights and biases stored in memory). The server performs matrix multiplications, attention computations, non-linear activations, and upsampling operations. As output, the server produces intermediate acoustic features (for example, a mel-spectrogram) and then a waveform array representing the generated voice, computed as sequences of floating-point audio samples.

### Step 9:

The server encodes the raw waveform into an audio file format.

The server uses an audio codec module to convert the raw waveform array into an audio file encoded in a predetermined format, such as WAV or MP3. As input, the server uses the float or integer sample sequence and encoding parameters including sample rate, bit depth, and channel count. As output, the server generates a binary audio file buffer by performing quantization, framing, header construction, and optional compression.

### Step 10:

The server sends the encoded voice data to the terminal.

The server encapsulates the binary audio file buffer into a response message, sets appropriate headers (such as content type and length), and transmits the response through the communication interface back to the terminal. As input, the server uses the encoded audio buffer and response metadata. As output, the server sends a network packet stream that carries the voice data to the terminal, and records log entries linking the request and response identifiers for traceability.

### Step 11:

The terminal receives and decodes the voice data.

The terminal reads the incoming network packets, reconstructs the binary audio buffer, and passes it to an audio decoder module. As input, the terminal uses the network response and its headers. As output, the terminal obtains a playable audio stream or decoded sample buffer by performing buffer assembly, header parsing, and codec decoding operations.

### Step 12:

The terminal plays the generated voice to the user.

The terminal initializes an audio playback pipeline with the decoded audio stream, sends the digital samples to a digital-to-analog converter, and outputs sound through the speaker or headphones. As input, the terminal uses the decoded audio buffer and playback control commands (such as play or stop). As output, the terminal produces an analog audio signal resulting in audible speech that reflects the pitch, speed, and style originally specified by the user.

### Step 13:

The user evaluates the generated voice and may modify parameters.

The user listens to the playback and compares the perceived voice characteristics with the intended voice profile. As input, the user uses the auditory output from the terminal and the memory of the previously selected parameters. As output, the user makes a decision either to accept the generated voice or to operate the terminal again to adjust pitch, speed, style, or emotional tone, thereby creating new input data for a subsequent processing cycle.

### Step 14:

The server processes attribute information for virtual object generation.

The server receives, from the terminal, structured attribute information representing properties of a virtual object, such as age category, personality type, and visual style preferences. As input, the server uses the attribute data object transmitted by the terminal. As output, the server produces a descriptive prompt sentence for image generation, such as “Generate a friendly, youthful virtual character with medium-length hair and a casual outfit.”, by mapping attributes to phrases and applying the same type of text construction operations as in voice prompt generation.

### Step 15:

The server processes dialog content to estimate a user emotional state.

The server receives text information and symbol information from the terminal, representing dialog messages and associated emoticons or symbols. As input, the server uses the sequence of messages in a session. The server tokenizes the text, encodes symbols as vectors, and feeds these representations into a trained neural classifier. As output, the server produces an emotional state label and a probability distribution over candidate emotional states by computing activations through the classifier's layers and applying a softmax operation.

### Step 16:

The server generates a reassurance message prompt sentence based on the emotional state.

The server uses the estimated emotional state and recent dialog context to construct a prompt sentence for a generative AI model for text generation. As input, the server uses the emotional state label (for example, “anxious” or “sad”) and a subset of the user's recent messages. As output, the server generates a prompt sentence, such as “Generate a gentle, reassuring message to comfort a user who is feeling anxious about their current situation.”, by selecting appropriate templates and inserting state-specific phrases.

### Step 17:

The server generates a reassurance message and optionally modifies voice prompts.

The server supplies the reassurance-message prompt sentence to a generative AI model for text and receives a reassurance message as output. As input, the server uses the reassurance prompt and the text model parameters. As output, the server obtains a natural language message string and transmits it to the terminal for display. When the server also intends to generate voice corresponding to this message, the server augments the previously constructed voice generation prompt sentence with emotional state information and regenerates the voice prompt, such as “Generate a calm, soft-spoken voice with slow speed and a gentle tone to reassure a user who is feeling anxious.”, thereby producing an updated prompt sentence that is passed into the voice-generation flow described in the preceding steps.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional interactive systems that employ generative AI models typically treat prompt sentences as static text templates that are manually authored and only loosely coupled to runtime user context. As a result, such systems are not well adapted to dynamically changing user attributes, multi-modal emotional signals (for example, text mixed with visual symbols), or cross-channel outputs such as coordinated visual content, audio content, and textual responses. In many cases, the server simply forwards raw user input to a generative AI model, receives an output, and then renders that output on a terminal device without performing any structured transformation of the input into higher-level abstractions, or any systematic control of the model's behavior based on past interaction history. This leads to several technical problems in the field of computer systems.

First, because the relationship between low-level user input (for example, specific words, emojis, and parameter values) and the internal control of the generative AI model is weak, the server cannot consistently control the output style, emotional tone, or modality of the generated content. The same or similar inputs may produce widely varying outputs, which degrades predictability and stability of the user interface at the system level.

Second, existing systems generally do not perform structured, machine-interpretable emotion quantification from mixed character information and visual symbols, and do not feed such quantified emotional states back into the prompt sentences and model control parameters. The absence of a systematic emotion representation means that the server cannot adjust generation parameters (for example, output length, tone, or content constraints) in a fine-grained way. This prevents the server from optimizing computational usage of generative AI models and from maintaining coherent response behavior over time.

Third, conventional architectures often generate each modality in isolation: an image for a character, a piece of text for a reply, and an audio clip for speech, without a unified orchestration mechanism at the server. This separation causes increased coordination overhead, duplicated computations, and inconsistent presentation across modalities (for example, a cheerful voice over a sad textual response). The lack of a server-centric mechanism for constructing integrated response data also complicates client logic, as terminal devices must manually correlate disparate outputs.

Fourth, these limitations collectively result in suboptimal use of computational resources. Generative AI models are typically executed in a stateless, one-shot fashion, ignoring previously stored interaction histories and emotion traces. Without leveraging such histories, the server cannot adapt prompts or output control conditions to improve convergence of the models toward desired behaviors, leading to unnecessary model invocations, redundant content generation, and unstable user experiences. This is a concrete inefficiency in the way computers and networks orchestrate and control AI inference services.

Accordingly, there is a need for a server-side technique that: (i) systematically converts user-provided attributes, voice parameters, and multi-modal emotional signals into higher-level descriptive expressions; (ii) dynamically generates structured prompt sentences for different types of generative AI models on the basis of quantified emotional states and stored interaction histories; and (iii) produces integrated, cross-modal response data (visual, audio, and textual) in a coordinated manner. By addressing these technical issues, such a system can improve the functioning of computer systems that orchestrate generative AI models, resulting in more controllable, efficient, and stable behavior at the server and network level, rather than merely providing an abstract improvement in user experience.

The specific processing by the specific processing unit 290 of the data processing device 12 in Application Example 2 is realized by the following means.

The present invention provides a server comprising a processor configured to receive, from a terminal device, attribute information, voice parameters, and mixed character information and visual symbols input by a user; convert the attribute information and the voice parameters into higher-level descriptive expressions; generate, on the basis of the higher-level descriptive expressions, prompt sentences for respective generative AI models including at least an image-generation model and a voice-generation model; normalize the mixed character information and visual symbols to generate analysis data for natural language processing; quantify, from the analysis data, an emotional state including a plurality of emotion types; dynamically generate, on the basis of the quantified emotional state and the mixed character information and visual symbols, a prompt sentence for a text-generation model, the prompt sentence including explicit constraints on style, tone, and output length; provide instruction information including the respective prompt sentences and control parameters to the generative AI models to cause generation of visual information, voice information, and response information; associate the generated visual information, voice information, and response information with one another to construct integrated response data; transmit the integrated response data to the terminal device; and store the quantified emotional state together with interaction history data, and update, on the basis of the stored data, at least one of expression content of subsequent prompt sentences and output control conditions for the generative AI models so as to adaptively modify later response generation processing. This enables the server to implement a computer-centric orchestration layer that transforms low-level, multi-modal user inputs into structured, context-aware prompt sentences and coordinated control signals for heterogeneous generative AI models, thereby improving the determinism, efficiency, and cross-modal consistency of AI-based content generation at the system level.

The term “processor” refers to an electronic processing circuit or a combination of hardware and software elements configured to execute instructions and perform arithmetic and logical operations, including at least one central processing unit and optionally one or more accelerators such as graphics processing units or dedicated AI accelerators.

The term “terminal device” refers to an information processing apparatus operated by a user, such as a mobile computing device, a wearable computing device, or a general-purpose computing device, that is capable of transmitting input information to a server and presenting output information received from the server.

The term “attribute information” refers to structured data representing characteristics of a virtual object or a user preference, including but not limited to items such as color, shape, style, body type, or other high-level descriptors indicating visual or behavioral features.

The term “higher-level descriptive expression” refers to a natural-language or symbolic representation in which specific attribute information or parameters are abstracted and generalized into a form suitable for direct use as a control instruction or condition for a generative AI model.

The term “generative AI model” refers to a machine learning model configured to generate output data such as images, text, or audio on the basis of input conditions, including at least models based on neural network architectures that transform input tokens or embeddings into newly synthesized content.

The term “prompt sentence” refers to a sequence of tokens, typically represented as a text string, that encodes instructions, constraints, or contextual information and is provided as an input condition to a generative AI model to control behavior and characteristics of generated output.

The term “instruction information” refers to data transmitted from the processor to a generative AI model, including at least one prompt sentence and, optionally, associated control parameters, that specifies a generation task and governs how the generative AI model produces output data. The term “virtual object” refers to a non-physical entity represented in digital form, including but not limited to an avatar, a character, or any graphical representation that can be displayed or manipulated within a user interface.

The term “visual information” refers to data representing at least one visual appearance of an object or scene, such as raster images, vector graphics, or other renderable formats, that can be presented on a display of the terminal device.

The term “voice parameters” refers to configuration values specifying characteristics of synthesized or rendered speech, including at least pitch, speaking speed, accent, timbre, and other properties influencing how text is converted into audio.

The term “information to be voiced” refers to content that is to be converted into audio output, including at least text strings representing sentences, phrases, or words, and optionally metadata indicating emphasis, pauses, or prosodic features.

The term “voice generation AI model” refers to a generative AI model configured to synthesize audio signals representing speech or other sound from textual or symbolic input and associated parameters, such as a text-to-speech model.

The term “voice synthesis parameters” refers to control values supplied to a voice generation AI model that determine technical properties of the generated audio output, including sampling characteristics, loudness normalization, and fine-grained prosodic adjustments.

The term “character information” refers to textual data composed of characters, including letters, digits, punctuation marks, and other written symbols, that is input by a user and may express semantic content, intent, or emotional state.

The term “visual symbols” refers to non-textual or semi-textual marks included in user input, such as emojis, icons, pictographs, or other symbolic representations, that visually convey emotion, status, or contextual nuance in conjunction with or independent of character information.

The term “normalize” refers to a process of transforming input data into a standard representation, including at least converting character encodings, unifying formats, separating or annotating visual symbols, and performing operations such as lowercasing or token standardization to facilitate subsequent analysis.

The term “analysis data sequence” refers to a series of tokens or data units derived from normalized character information and visual symbols that is structured for processing by natural language processing algorithms or models.

The term “natural language processing” refers to a set of computational techniques and models that enable a computer system to analyze, interpret, and generate human language, including operations such as tokenization, parsing, part-of-speech tagging, entity recognition, and sentiment or emotion analysis.

The term “emotional state” refers to a representation of one or more emotions inferred from input data, typically expressed as one or more emotion categories and, optionally, associated numerical scores indicating intensities or probabilities.

The term “plurality of types of emotions” refers to at least two distinct emotion categories, such as joy, sadness, anger, fear, surprise, or fatigue, that may be concurrently recognized and represented for a given user input.

The term “text-generation model” refers to a generative AI model that outputs text sequences, such as sentences or paragraphs, in response to an input prompt sentence, and is typically implemented using a sequence model architecture such as a transformer-based neural network.

The term “response information” refers to data generated by a generative AI model that is intended to be provided to a user as a reply or reaction, and that may include textual content, metadata, or other information elements conveying meaning or guidance.

The term “support information” refers to response information that is generated to aid or comfort the user, including messages designed to provide reassurance, suggestions, or guidance tailored to the user's inferred emotional state.

The term “sense of security” refers to a perceived reduction in anxiety or discomfort by the user, resulting from response information or support information that reflects and addresses the user's emotional state in a stable and empathetic manner.

The term “integrated response data” refers to a combined data structure that associates visual information, voice information, and response information so that the respective modalities are coherently aligned and can be presented in a consistent manner by the terminal device.

The term “interaction history” refers to stored information representing past exchanges between the user and the system, including at least past user inputs, system responses, and corresponding emotional states, which can be referenced to influence future processing.

The term “output control conditions” refers to parameters or rules applied to the operation of generative AI models, including constraints on style, tone, content filters, temperature, length limits, or other generation settings that influence how outputs are produced.

The term “context information” refers to data that characterizes a current interaction in relation to prior interactions and user state, including at least attribute information, emotional state, and interaction history, and that is used to condition prompt sentences and model behavior.

The term “image-generation model” refers to a generative AI model that produces image data from input conditions such as textual descriptions or latent vectors, and that is capable of synthesizing visual representations corresponding to a virtual object.

The term “speaker characteristics” refers to qualitative properties of a synthesized or rendered voice, such as perceived gender, age, accent, timbre, and speaking style, that distinguish one synthetic speaker from another.

The term “speech style” refers to mannerisms and prosodic patterns of generated speech, including rhythm, emphasis, intonation, and expressiveness, that influence how a message is audibly conveyed to the user.

In one embodiment, a server cooperates with at least one terminal and at least one user to implement the claimed system. The server includes a processor, a memory, and a communication interface. The processor executes program modules stored in the memory. The program modules include at least a prompt-generation module, an emotion-analysis module, a model-orchestration module, a data-management module, and a response-integration module. The terminal includes a display, an audio output device, an input interface, and a communication interface. The terminal may be realized as a smartphone, a tablet computer, a wearable device such as smart glasses, or a general-purpose personal computer.

The server uses general-purpose hardware such as a central processing unit and may further use accelerators such as a graphics processing unit or a specialized neural network accelerator. For example, the server may run on a virtual machine or container platform hosted on a cloud computing infrastructure and may use a graphics processing unit to perform matrix-multiplication operations involved in inference of a generative AI model. The server executes an operating system such as a general-purpose server operating system and an application framework such as a Web application framework. The server also communicates with external AI inference services that host generative AI models for image generation, text generation, and voice generation.

The terminal executes a client application that provides a graphical user interface. The user uses the terminal to input attribute information for a virtual object, voice parameters, and textual messages including visual symbols. The terminal converts these inputs into structured data and transmits the data to the server via a communication network such as the Internet using a standardized protocol such as HTTPS. The terminal also receives integrated response data from the server and presents visual information, voice information, and response information to the user. For example, the terminal displays a virtual character image on the display, outputs synthesized speech via a loudspeaker, and renders generated text in a chat interface.

The server stores, in the memory or in an external storage device, data structures for representing attribute information, voice parameters, character information, visual symbols, emotional state, prompt sentences, and interaction history. The data-management module defines, for example, a record consisting of fields such as attribute_vector, voice_vector, emotion_vector, prompt_text, and model_control_parameters. The server uses fixed-length or variable-length arrays of numerical values to represent the vectors and uses character strings to represent the prompt sentences. By structuring the data in this way, the server can efficiently index, retrieve, and update the information, thereby improving memory locality and reducing database access overhead compared to unstructured logging.

The server converts attribute information into higher-level descriptive expressions suitable for conditioning a generative AI model. For instance, the server receives attributes such as “hair color: blue,” “eye color: green,” “body type: slim,” and “style: sporty,” and converts them into a human-readable prompt sentence. In one example, the server generates the following prompt sentence for an image generative AI model:
“Generate an anime-style full-body character with blue hair, green eyes, and a slim sporty body, smiling at the viewer.”

The server passes this prompt sentence to an image generative AI model implemented as a deep neural network, for example a diffusion model having a transformer-based text encoder and a convolution-based image decoder. The image generative AI model accepts tokenized text as input, converts the text into embedding vectors, and iteratively refines a latent image representation by repeatedly applying learned denoising steps. The model then decodes the latent representation into a raster image. Because the server supplies a prompt sentence that has been normalized into a higher-level expression and stripped of unnecessary user-specific noise, the model can converge to a suitable output with fewer inference steps. As a result, the server reduces computational workload and improves end-to-end latency.

The server also converts voice parameters and information to be voiced into higher-level descriptive expressions and uses them to construct prompt sentences or configuration descriptors for a voice generation AI model. For example, the server receives voice parameters indicating “pitch: low,” “speed: fast,” and “accent: British,” and receives a text string such as “You worked very hard today. Please take a good rest.” The server generates a descriptive expression such as: “Read the following text in a low-pitched, fast British English voice with a calm and gentle tone: ‘You worked very hard today. Please take a good rest.’”

The server then maps each qualitative descriptor to quantitative parameters of the voice generation AI model, such as a normalized pitch shift value, a speaking-rate factor, and a specific voice identifier in the model's configuration. The voice generation AI model may be implemented as a sequence-to-sequence neural network that first converts text into a mel-spectrogram and then uses a neural vocoder such as a WaveNet-type model or a generative adversarial network to synthesize an audio waveform. The server's mapping from higher-level descriptive expressions to concrete model parameters allows the voice generation AI model to be controlled more precisely and consistently than in a system that merely forwards raw user inputs. Therefore, the system decreases variance in speech output, reduces the need for repeated trial-and-error invocations, and improves computational efficiency.

The server further performs emotion analysis on mixed character information and visual symbols transmitted by the terminal. The emotion-analysis module of the server uses a pipeline that includes deterministic natural language processing methods and a trained neural network classifier. The server normalizes Unicode text, tokenizes the text, separates visual symbols such as emojis and pictograms, and maps each visual symbol to a standardized textual label. For example, the server maps a tired-face emoji to a label such as “tired face, exhausted.” The server then concatenates the original text and the labels to form an analysis string. This analysis string is converted into a sequence of tokens and passed to a neural network classifier, for instance a transformer-based model fine-tuned for multi-label emotion recognition. The classifier computes, using attention mechanisms and learned weights, an emotion_vector representing probabilities or intensities of multiple emotion categories, such as joy, sadness, anger, anxiety, and fatigue. The server stores this emotion_vector with the corresponding interaction record. In contrast to a simple keyword-based sentiment analysis, the server uses a multi-head attention architecture that captures contextual relationships between words and visual symbols, and uses a multi-label loss function such as binary cross-entropy during training. The server trains the classifier offline using a labeled dataset consisting of text and visual symbols paired with multiple emotion labels. The server updates model weights during training using gradient-descent-based optimization and uses regularization techniques such as dropout and data augmentation, where data augmentation includes alterations such as synonym replacement and emoji permutation. This training configuration enables the deployed classifier to recognize complex, overlapping emotions in real time with high accuracy and low false positive rates. As a result, the server obtains a more informative and stable emotion_vector than conventional single-label or rule-based methods.

The server uses the quantified emotional state and the interaction history to dynamically generate prompt sentences for a text-generation model that acts as the generative AI model for response information. The model-orchestration module of the server constructs prompt sentences that combine: (i) the user's latest text message, (ii) the emotion_vector compressed into one or more textual descriptions such as “tired and stressed,” and (iii) explicit constraints on style, tone, and length. For example, when the user sends the message “I'm really tired today [symbol] ,” the server may generate a prompt sentence such as:
“User message: ‘I'm really tired today [symbol] ’

Detected emotions: tired and stressed.

Please generate a short, empathetic reply that acknowledges the user's effort and gently encourages rest. Use a warm and supportive tone, and do not give medical advice.”

The server then supplies this prompt sentence to a transformer-based text-generation model. The model uses its internal self-attention layers to compute contextual embeddings over the combined instruction and user text, then autoregressively generates output tokens until a stop condition is met. The server controls model hyperparameters such as temperature, top-k, or top-p sampling thresholds based on the emotion_vector and on stored interaction history. For instance, in a highly stressed emotional state, the server may decrease temperature and output length to reduce the probability of unexpected or overly complex responses. This dynamic control reduces variability of the model's output and reduces risk of inappropriate content, thereby improving robustness of the computer system.

The server associates generated visual information, voice information, and response information into integrated response data. The response-integration module of the server constructs an object linking identifiers of images, audio files, and text messages that belong to the same interaction. The server assigns shared session identifiers and sequence numbers to each component and stores them in an indexed database. This internal association reduces the need for the terminal to perform correlation logic and avoids mismatches between modalities when network delays or retries occur. The server compresses the integrated response data using appropriate formats, for example image compression and audio compression, and transmits the data over the communication network. In some embodiments, the server precomputes cache keys for common combinations of emotion_vector and attribute information and reuses previously generated images or audio segments. This caching strategy reduces redundant inference and therefore reduces computational load and network traffic.

The server further maintains interaction history and uses it to update prompt sentences and model output control conditions. The server records, for each interaction, user input, emotion_vector, prompt sentences used, and model outputs. The server then applies an adaptation algorithm that adjusts templates, weights for emotion-to-style mapping, and control parameters such as maximum length and sampling thresholds. For example, when the interaction history indicates that responses with a certain style yield longer subsequent conversations or fewer user corrections, the server may bias future prompt sentences toward that style when similar emotions are detected. This adaptation is implemented through deterministic rules and parameter updates stored in configuration tables, not through re-training of the underlying generative models. As a result, the adaptation can be performed at runtime without interrupting service, and the prompt-generation layer gradually improves quality and efficiency of the system's outputs.

The server thereby improves computer technology in multiple technical aspects. First, by converting low-level user inputs into higher-level descriptive expressions and structured prompt sentences, the server reduces entropy in the inputs to the generative AI models, which leads to fewer inference steps and reduced computation time. Second, by quantifying emotional state into a numerical emotion_vector and using it to drive model parameters, the server provides a precise control interface between deterministic logic and probabilistic generative models, enabling more stable and predictable operation than conventional trial-and-error prompting. Third, by integrating modal outputs into a single data structure and by caching at the server, the system reduces overall communication overhead and reduces redundant model use. Fourth, by exploiting interaction history, the server can tune control conditions to minimize error rates and to improve convergence of outputs to the desired range, which constitutes a technical improvement in how a computing system orchestrates and manages heterogeneous AI services. The user uses the system in practical use cases such as personalized audio content, emotionally adaptive conversational agents, and adaptive information recommendation. In one example, the user selects an audiobook via the terminal and sets voice parameters such as “low pitch, fast speed, British accent.” The server constructs the prompt sentence:
“Read the provided audiobook text in a low-pitched, fast British English voice.”

The server then generates and streams the audiobook in the selected voice to the terminal. During playback, the user may send text such as “I'm getting tired” together with a sleepy emoji. The server recognizes the emotional state and generates a message such as “You have listened a lot today. It might be a good time to rest.” The server may also adjust playback length or suggest pausing. This behavior illustrates how the server controls not only text and audio generation but also timing and selection of content, thereby functioning as a technical controller of user-terminal interaction rather than a passive text generator.

In another example, the user interacts with a virtual character through the terminal. The user initially specifies character attributes such as “blonde hair, blue eyes, adventurous style,” and the server generates the prompt sentence:
“Generate a high-resolution character with blonde hair, blue eyes, and an adventurous appearance, wearing casual fantasy clothing and smiling kindly.”

The resulting image is displayed on the terminal. When the user later sends “Today was fun, but I am a little tired,” the server detects mixed emotions of joy and fatigue and generates a prompt sentence for the text-generation model:
“User message: ‘Today was fun, but I am a little tired.’

Detected emotions: joy and fatigue.

Please generate a supportive message that celebrates the enjoyable day while gently encouraging the user to rest.”

Based on the generated text, the server may then generate speech in a matching style and recommend content such as energetic songs and relaxing videos. The server thereby coordinates multiple generative AI models through explicit prompt sentences and data structures, so that each model receives consistent, context-aware inputs and the terminal receives coherent multimodal outputs.

In still another embodiment, the server uses alternative model architectures. The image generative AI model may be a generative adversarial network that maps random noise vectors combined with text embeddings to images, and the text-generation model may be a recurrent neural network instead of a transformer. The emotion classifier may be implemented as a convolutional neural network applied to character n-gram features rather than token-level embeddings. The crucial point is that the server always acts as an intermediate controller that transforms raw inputs into structured prompt sentences and that applies systematic, emotion-conditioned control parameters. This architecture ensures that the technical contribution resides in the server-side orchestration mechanism, not in any particular black-box model.

The server may further incorporate additional modules for privacy control, security, and fault tolerance. For example, the server may anonymize user identifiers in stored interaction history while preserving emotion_vector and attribute information, and may replicate prompt-generation rules across multiple physical machines for high availability. Such configurations demonstrate that the described system can be implemented using conventional hardware and software components, and that the specific combination of data structures, prompt generation rules, emotion-conditioning mechanisms, and multimodal output integration yields a tangible improvement in computer system performance and behavior.

Through these embodiments and variations, the server, the terminal, and the user cooperate so that the server transforms raw multi-modal user inputs into structured, context-aware prompt sentences for multiple generative AI models and returns integrated response data. The described configuration improves processing efficiency, output stability, and cross-modal consistency of AI-based content generation, and thereby constitutes a concrete improvement to computer technology itself rather than an abstract automation of human mental tasks.

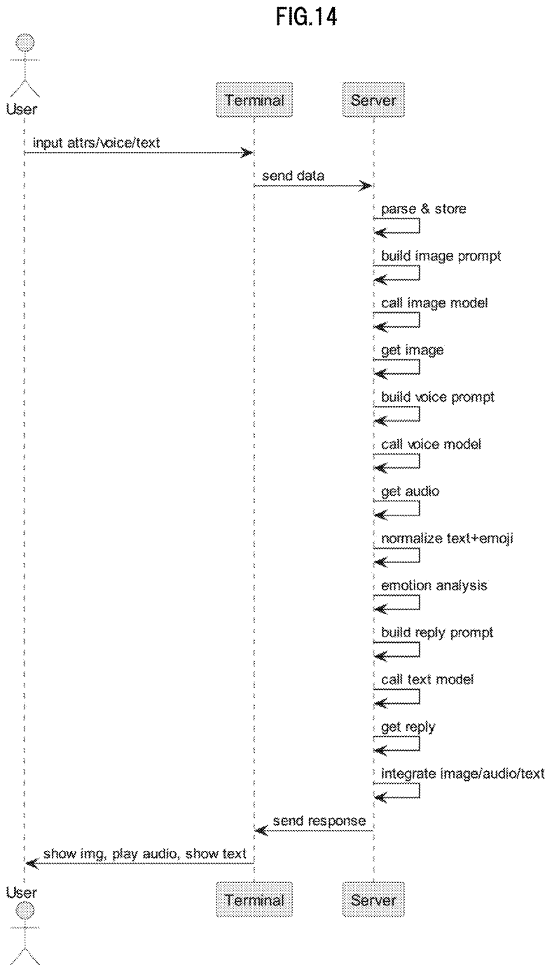

The following describes the processing flow using FIG. 14.

### Step 1:

User operates the terminal to input data.

User specifies attribute information for a virtual object (for example, hair color, eye color, style), voice parameters (for example, pitch, speed, accent), and character information including visual symbols (for example, “I'm really tired today [symbol] ”).

Input: raw user inputs from UI components (text fields, sliders, buttons, emoji picker).

Output: structured input data inside the terminal (for example, internal objects representing attributes, voice parameters, and message text).

Terminal converts UI state into structured records, assigns field names to each item (for example, “hair_color=blue”), and temporarily stores them in memory.

### Step 2:

Terminal transmits structured data to the server.

Terminal serializes the structured input (attributes, voice parameters, and message text with emojis) into a request payload and sends it via a communication interface over a network connection using a standardized protocol.

Input: structured input data created in Step 1.

Output: network request containing the structured data, delivered to the server.

Terminal performs data encoding (for example, UTF-8 for text), encapsulates the data in a message body, attaches session and user identifiers in headers, and transmits the message to the server endpoint.

### Step 3:

Server receives the request and parses the data.

Server accepts the incoming message through a network stack, decodes the payload, and maps each field into internal data structures such as attribute_vector, voice_vector, and message_text.

Input: network request from the terminal containing structured user data.

Output: internal server-side objects representing attributes, voice parameters, and character information including visual symbols.

Server validates the data types, checks for missing fields, creates or updates a session record in storage, and logs metadata such as timestamps and request identifiers.

### Step 4:

Server converts attribute information into a higher-level descriptive expression.

Server reads the attribute_vector, resolves each attribute to an abstract descriptor, and concatenates these descriptors into a natural-language prompt sentence for an image generative AI model.

Input: attribute information object (for example, hair_color, eye_color, body_type, style).

Output: prompt sentence for controlling an image generative AI model.

Server executes string-building logic using templates such as “Generate an anime-style full-body character with [hair_color] hair, [eye_color] eyes, and a [body_type] [style] body, smiling at the viewer,” replacing placeholders with actual attribute values.

### Step 5:

Server requests image generation from a generative AI model.

Server sends the prompt sentence and option parameters (for example, resolution, style tags) to an image generative AI model hosted locally or remotely, and waits for the resulting visual information.

Input: prompt sentence generated in Step 4 and generation parameters (for example, target resolution, number of samples).

Output: generated visual information (for example, an image file or binary image data).

Server formats a model-specific request object, transfers the prompt sentence into the model's interface, and triggers inference; the model performs internal tensor operations to produce the image, which the server then receives and stores.

### Step 6:

Server converts voice parameters and information to be voiced into a higher-level descriptive expression.

Server inspects the voice_vector and the text to be spoken and creates a descriptive control sentence that indicates voice style, pitch, speed, and accent in natural language.

Input: voice parameters (for example, pitch, speed, accent) and text content to be vocalized.

Output: descriptive expression and configuration parameters for a voice generation AI model.

Server maps qualitative values (for example, “low pitch,” “fast speed,” “British accent”) to numeric or symbolic model parameters, and generates a control sentence such as “Read the following text in a low-pitched, fast British English voice with a calm and gentle tone: ‘ . . . ’.”

### Step 7:

Server requests voice synthesis from a voice generation AI model.

Server provides the descriptive expression and corresponding numeric voice parameters to a voice generation AI model and instructs the model to synthesize an audio waveform.

Input: voice control sentence and mapped voice synthesis parameters from Step 6.

Output: synthesized voice information (for example, audio data representing speech).

Server converts the control sentence and parameters into fields required by the model, calls the model's inference endpoint, and receives compressed audio data which it then stores and indexes.

### Step 8:

Server normalizes character information and visual symbols for emotion analysis.

Server processes the combined message_text to separate textual characters and visual symbols and creates a normalized representation suitable for natural language processing.

Input: character information including visual symbols from Step 3.

Output: normalized analysis string and token sequence for emotion analysis.

Server performs operations such as Unicode normalization, lowercasing, tokenization, and emoji extraction; server replaces each emoji with a textual label (for example, “ [symbol] ”→“tired face, exhausted”) and concatenates the original text with the labels to form an analysis string.

### Step 9:

Server computes an emotional state from the normalized data.

Server passes the tokenized analysis string to an emotion classifier, which may be a trained neural network, and obtains a numerical emotion_vector representing multiple emotion categories.

Input: normalized token sequence from Step 8.

Output: emotional state representation including emotion labels and scores.

Server converts tokens into embeddings, runs them through the classifier model, receives output logits for each emotion class, applies activation functions (for example, sigmoid), and stores the resulting scores in an emotion_vector structure.

### Step 10:

Server generates a context-aware prompt sentence for a text-generation model.

Server uses the latest user message, the emotional state, and stored interaction history to construct a prompt sentence instructing a text-generation model how to respond.

Input: user message, emotion_vector from Step 9, and relevant interaction history from storage.

Output: context-aware prompt sentence for a text generative AI model.

Server selects textual descriptions for dominant emotions (for example, “tired,” “stressed”), inserts them into a template, adds explicit constraints on tone and length, and builds a prompt such as “User message: ‘I'm really tired today [symbol] ’. Detected emotions: tired and stressed. Please generate a short, empathetic reply that acknowledges the user's effort and gently encourages rest. Use a warm and supportive tone, and do not give medical advice.”

### Step 11:

Server requests response generation from a text-generation model.

Server submits the context-aware prompt sentence to a text-generation model and retrieves a text response that matches the specified style and constraints.

Input: prompt sentence from Step 10 and generation control parameters (for example, temperature, maximum token count).

Output: generated response information in text form.

Server encodes the prompt into tokens, sends it to the model's inference interface, receives a sequence of output tokens generated autoregressively, decodes them into a text string, and applies post-processing such as trimming, safety filtering, and formatting.

### Step 12:

Server constructs integrated response data.

Server associates the generated visual information, synthesized voice information, and generated text response into a single integrated object linked to the same interaction.

Input: image data from Step 5, audio data from Step 7, and response text from Step 11, along with the emotional state and session identifiers.

Output: integrated response data structure ready for transmission to the terminal.

Server creates a record containing references or URLs to the image and audio files, embeds the response text, attaches emotion and session fields, and stores this composite record in a database; server also prepares a compact representation to send to the terminal.

### Step 13:

Server transmits the integrated response data to the terminal.

Server encodes the integrated response data into a response message and sends it over the communication network to the terminal.

Input: integrated response data from Step 12.

Output: network response message delivered to the terminal.

Server serializes the data into a format suitable for transport, includes necessary headers and caching instructions, and sends the message through the communication interface while updating logs for delivery status.

### Step 14:

Terminal receives and parses the integrated response data.

Terminal extracts visual, audio, and text components from the received message and prepares them for presentation to the user.

Input: network response message from Step 13.

Output: separate internal resources for image display, audio playback, and text rendering.

Terminal decodes image and audio formats, stores them in local caches, parses the text response, and updates in-memory UI models to reflect the new content.

### Step 15:

Terminal presents the multimodal response to the user.

Terminal displays the virtual image, plays the synthesized voice, and shows the text response in the user interface so that the user can perceive the coordinated output.

Input: decoded image, audio, and text from Step 14.

Output: rendered visual content on a display, audible speech through an audio output device, and visible text in a chat or dialog interface.

Terminal invokes display routines to draw the image, uses the audio subsystem to start playback at an appropriate time, and renders the text in a message bubble associated with the virtual character or system persona.

### Step 16:

User interacts further based on the presented response.

User observes the generated character, listens to the voice, and reads the text response, and then decides whether to modify parameters, send a new message, or consume recommended content.

Input: multimodal presentation from Step 15.

Output: new user actions and inputs for a subsequent interaction cycle.

User may adjust attribute preferences, change voice settings, or send additional messages such as “That helped, but I am still a bit tired,” thereby providing new input that restarts the processing flow from Step 1 with updated context.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### SECOND EXEMPLARY EMBODIMENT

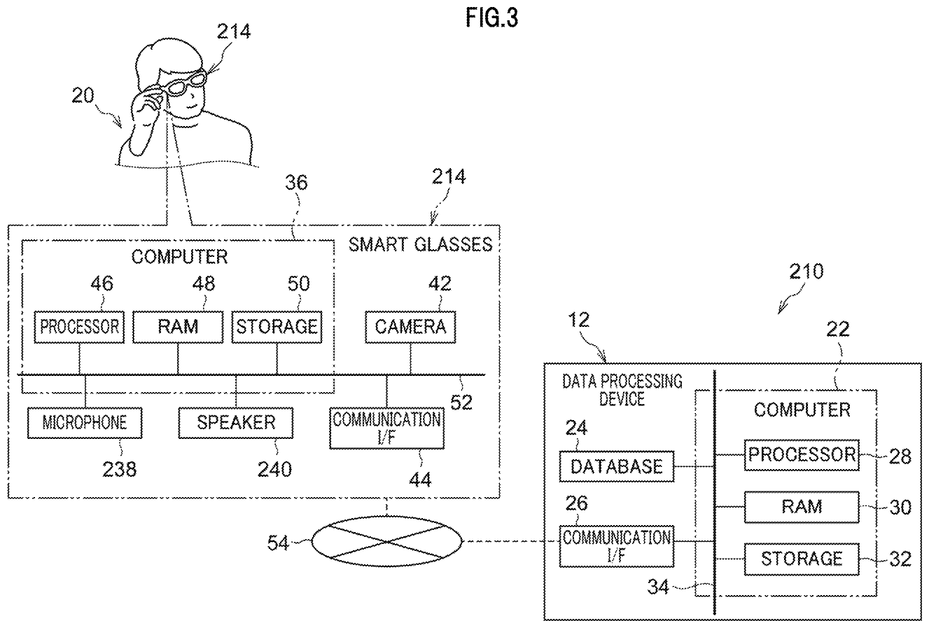

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

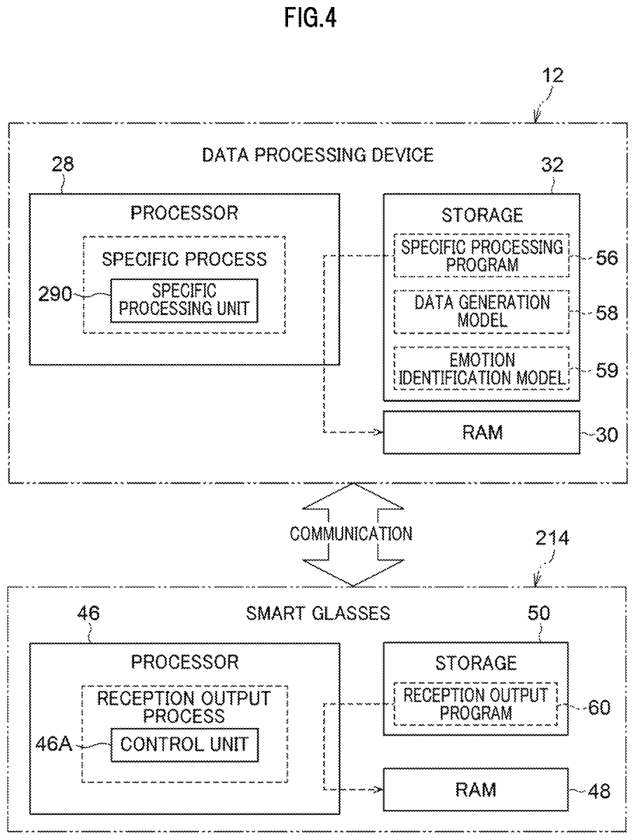

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### THIRD EXEMPLARY EMBODIMENT

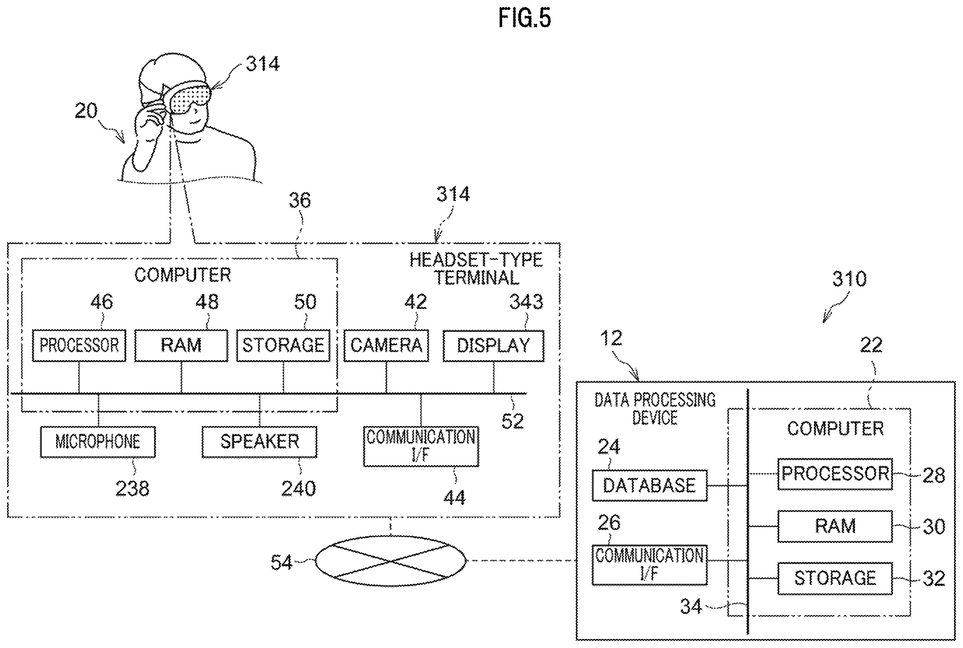

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

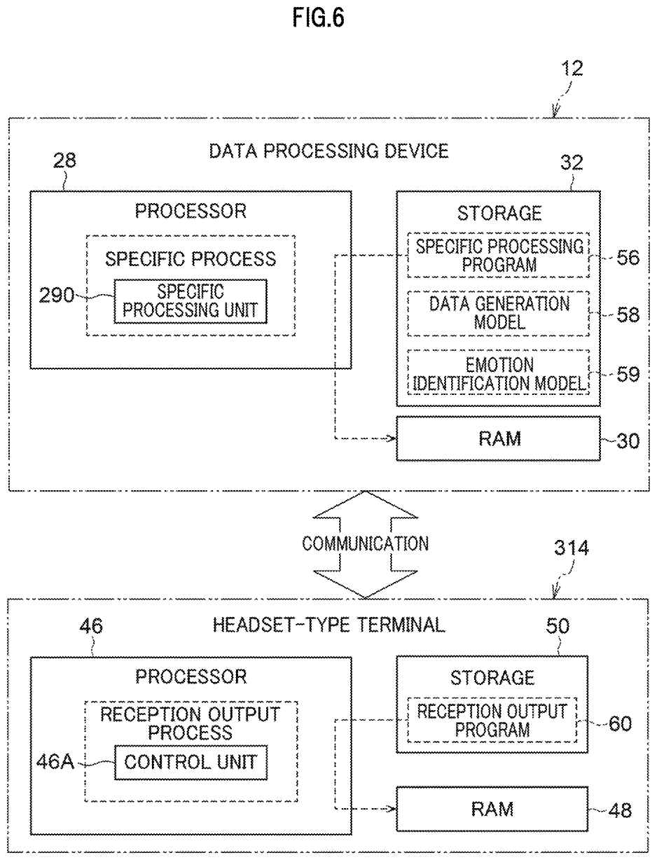

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314.

Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user.

Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### FOURTH EXEMPLARY EMBODIMENT

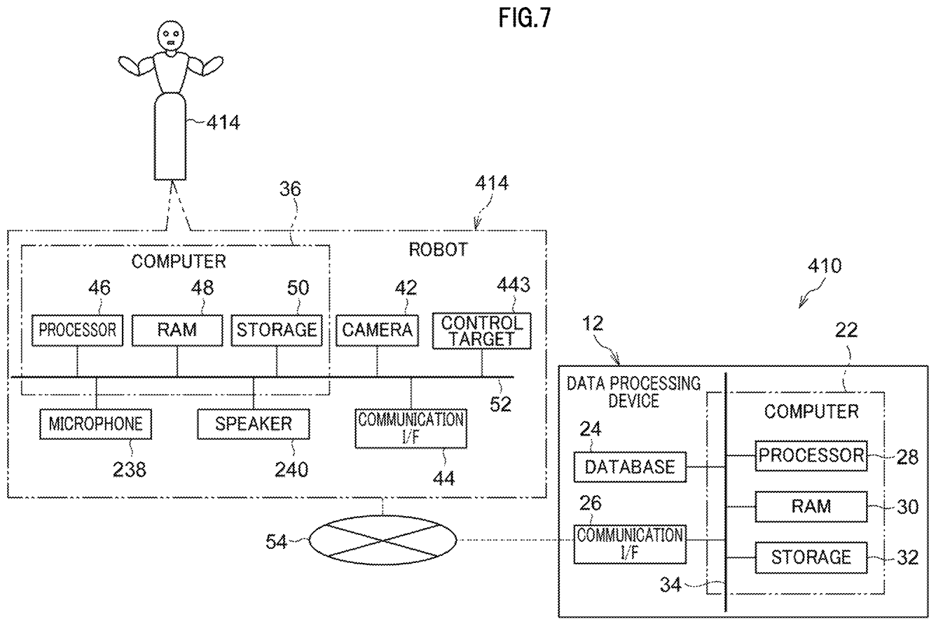

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

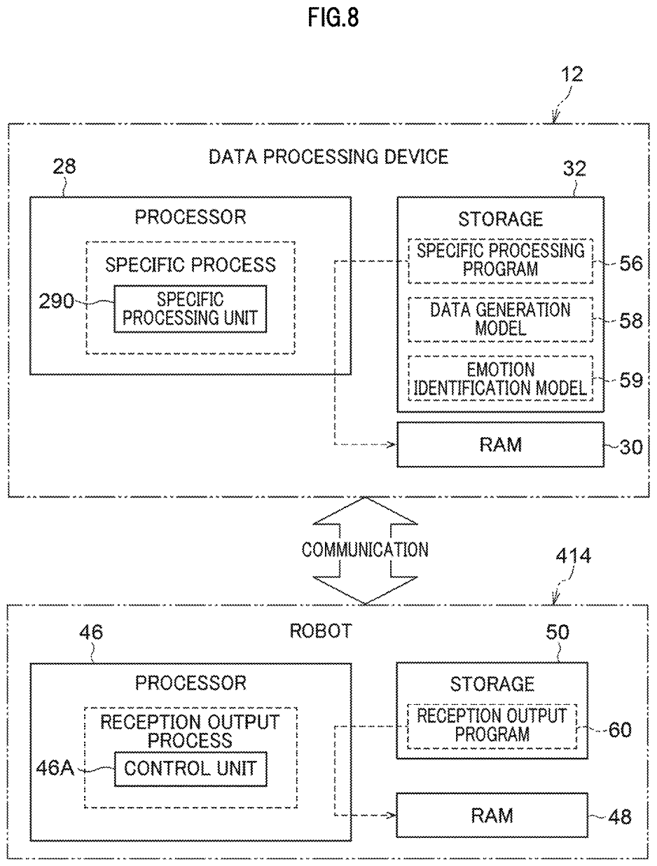

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

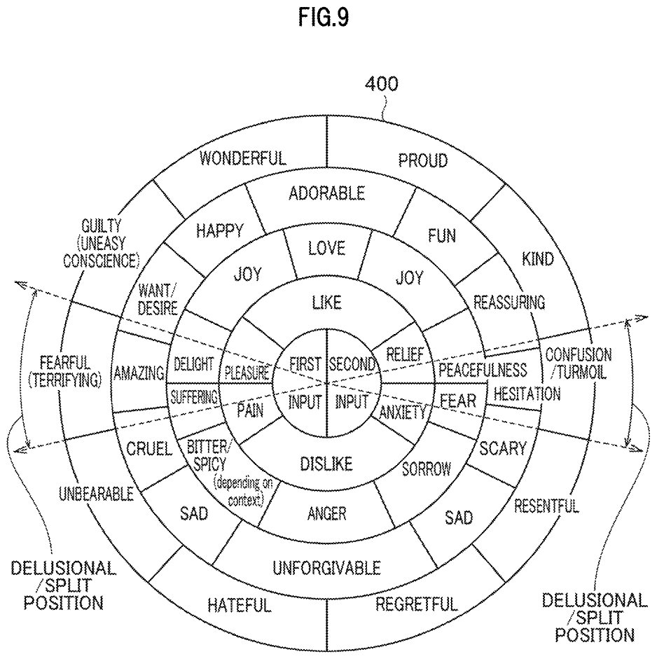

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

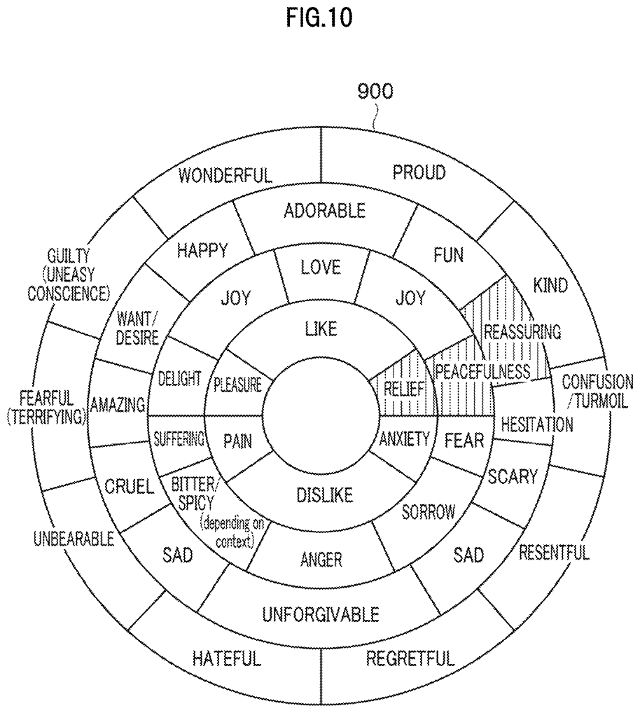

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (Saas).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
receive, from a user via an information processing terminal, attribute information and other feature information, convert the feature information into internal structured data, and generate generation instruction information including a prompt sentence in a natural language that contains the feature information,
select, based on the feature information and style information included in the generation instruction information, at least one of an image generative AI model and a voice generative AI model, preprocess the prompt sentence into an input format of a selected generative AI model, and cause the selected generative AI model to generate at least one of a visual representation or a voice representation of a virtual character,
analyze character information and symbol information received from the user in a chat format, estimate an emotional state of the user by using a natural language processing technique and an emotion classification model, generate a response prompt sentence including content for providing a sense of reassurance or support to the user according to the emotional state, cause a generative AI model to generate a message based on the response prompt sentence, and present the generated message to the user via the information processing terminal,
perform post-processing on image data output from the generative AI model when generating the visual representation of the virtual character, adjust at least one of a size, a shape, an image quality, and a background of an image, store an adjusted image in a storage device, and transmit reference information to the image stored in the storage device to the information processing terminal,
generate a voice generation prompt sentence including text information and speaker style information when generating the voice representation, cause a voice generative AI model to generate voice data based on the voice generation prompt sentence, encode the generated voice data into a predetermined audio format, and transmit the encoded voice data to the information processing terminal, and
automatically generate, based on the estimated emotional state, a new prompt sentence including an improvement proposal for the visual representation of the virtual character or a new prompt sentence including an improvement proposal for the voice representation, and, when the user selects the new prompt sentence, re-input the new prompt sentence to the generative AI model and execute a regeneration process.

### (Supplementary 2)

The system according to supplementary 1,
wherein the processor is configured to
insert feature information regarding a plurality of types of physical features, decorative features, and expression styles specified by the user into a predefined template, concatenate the feature information as a single prompt sentence, and provide the prompt sentence as input to an image generative AI model to cause the image generative AI model to generate image data reflecting the feature information.

### (Supplementary 3)

The system according to supplementary 1,
wherein the processor is configured to
generate a voice generation prompt sentence including at least one parameter indicating an emotional tone, a speaking rate, and a voice quality according to a selection of the user, provide the voice generation prompt sentence as input to a voice generative AI model to cause the voice generative AI model to generate a plurality of types of voice data reflecting the parameter, and present, to the information processing terminal, voice data selected by the user from among the plurality of types of voice data.

### Application Example 1

### (Supplementary 1)

A system comprising a processor,
wherein the processor is configured to
receive, from a user via an information processing terminal, attribute information representing characteristics of a virtual object, convert the attribute information into a natural language description expressed in terms of higher-level concepts, and generate a prompt sentence that instructs a generative AI model performing generation processing to generate the virtual object,
generate, on the basis of the attribute information and voice characteristic information associated with the virtual object, a prompt sentence that instructs a generative AI model performing voice output generation to generate voice data, and transmit the generated voice data to the information processing terminal,
analyze character information and symbol information expressing emotion that are received from the information processing terminal in a chat format, estimate an emotional state of the user by using a natural language processing model and an emotion estimation model, generate a prompt sentence for generating response content configured to provide psychological stability to the user on the basis of the emotional state and attributes of the virtual object, and cause at least one of text data of the response content and voice data obtained by converting the response content into speech to be presented by the information processing terminal,
sequentially receive, from the information processing terminal, update information of the attribute information, generate a new prompt sentence reflecting the update information, re-input the new prompt sentence to the generative AI model, and thereby update, in real time, image data or three-dimensional shape data of the virtual object and cause the updated virtual object to be presented by the information processing terminal as an avatar in a virtual space, and
accumulate, as conversation history, emotion estimation results based on the character information and the symbol information, and dynamically change contents of the prompt sentence and generation conditions in the generative AI model on the basis of the conversation history so as to continuously optimize an appearance of the virtual object, the voice characteristic information, and the response content for each individual user.

### (Supplementary 2)

The system according to supplementary 1,
wherein the processor is configured to
use, as the generative AI model, an information processing model that performs image generation processing, generate two-dimensional image data representing the virtual object or image data applicable to a surface of the virtual object on the basis of the higher-level concept representation of the attribute information included in the prompt sentence, and transmit the generated image data to the information processing terminal as appearance information of the avatar.

### (Supplementary 3)

The system according to supplementary 1,
wherein the processor is configured to
use, as the generative AI model, an information processing model that performs voice generation processing, generate a voice signal associated with the virtual object on the basis of the voice characteristic information and speaking-style characteristic information corresponding to the emotional state included in the prompt sentence, and transmit the voice signal to the information processing terminal to output the voice signal as speech from the avatar.

### Example 2

### (Supplementary 1)

A system comprising a processor,
wherein the processor is configured to
receive, from a terminal operated by a user, input information indicating voice characteristics including at least a pitch, a speaking speed, and a speaking style as numerical or symbolic values for voice generation, and store the input information in an internal data structure,
analyze the numerical or symbolic values for voice generation received from the terminal, and convert the numerical or symbolic values into a natural language description by using character string processing to generate, as a prompt sentence, a voice generation instruction sentence to be input to a generative artificial intelligence model,
input, via a communication network, a request including the voice generation instruction sentence to a generative artificial intelligence model for voice generation, and obtain voice data based on a voice waveform generation process performed by the generative artificial intelligence model,
encode the obtained voice data into a predetermined audio file format, transmit the encoded voice data to the terminal, and cause the terminal to present the encoded voice data to the user,
receive attribute information specified by the user as input information, and generate, as a prompt sentence, an instruction sentence that instructs a generative artificial intelligence model to generate a virtual object based on the attribute information,
and
analyze text information and symbol information received in a dialog format, estimate an emotional state of the user by using natural language processing, generate, as a prompt sentence, an instruction sentence that instructs a generative artificial intelligence model to generate a reassurance message based on a result of the estimation, and cause the reassurance message generated by the generative artificial intelligence model to be presented to the user via the terminal.

### (Supplementary 2)

The system according to supplementary 1,
wherein the processor is configured to
generate, as a prompt sentence, an instruction sentence that instructs generation of the virtual object based on the attribute information of the user, use a generative artificial intelligence model for image generation to generate image data of the virtual object, and cause the image data of the virtual object to be presented by the terminal.

### (Supplementary 3)

The system according to supplementary 1,
wherein the processor is configured to
add, to the voice generation instruction sentence, information indicating an emotional state corresponding to the result of the estimation of the emotional state of the user, and instruct the generative artificial intelligence model to generate voice data reflecting the emotional state.

### Application Example 2

### (Supplementary 1)

A system comprising a processor,
wherein the processor is configured to
receive attribute information input by a user via a terminal device, convert the attribute information into a higher-level descriptive expression, generate a prompt sentence for a generative AI model on the basis of the higher-level descriptive expression, and generate instruction information including the prompt sentence to cause generation of visual information of a virtual object by the generative AI model,
receive voice parameters and information to be voiced input by the user via the terminal device, convert the voice parameters and the information to be voiced into a higher-level descriptive expression, generate a prompt sentence for a voice generation AI model on the basis of the higher-level descriptive expression, and generate instruction information including the prompt sentence and voice synthesis parameters to cause generation of voice information by the voice generation AI model,
receive character information and visual symbols transmitted by the user via the terminal device, normalize the character information and the visual symbols to generate an analysis data sequence for natural language processing, and quantify an emotional state on the basis of the analysis data sequence so as to specify a plurality of types of emotions,
dynamically generate, on the basis of the specified emotional state, the character information, and the visual symbols, a prompt sentence for a generative AI model for response generation, and generate instruction information including the prompt sentence to cause generation of response information and/or support information that provides a sense of security by the generative AI model,
associate the generated visual information, the generated voice information, and the generated response information with one another to construct integrated response data, and transmit the integrated response data to the terminal device so as to cause display and reproduction by the terminal device, and
store the emotional state extracted from the character information and the visual symbols together with a past interaction history, and update an expression content of the prompt sentence and output control conditions for the generative AI model on the basis of a storage result so as to adaptively change subsequent response generation processing.

### (Supplementary 2)

The system according to supplementary 1,
wherein the processor is configured to
use context information including the attribute information and the emotional state to generate a prompt sentence for a generative AI model for image generation, and transmit instruction information including the prompt sentence to cause generation, by the generative AI model for image generation, of visual information of the virtual object corresponding to preferences and the emotional state of the user.

### (Supplementary 3)

The system according to supplementary 1,
wherein the processor is configured to
use the emotional state and sentence information corresponding to the response information to generate a prompt sentence and voice synthesis parameters for a voice generation AI model, and transmit instruction information including the prompt sentence and the voice synthesis parameters to cause generation, by the voice generation AI model, of voice information having speaker characteristics and a speech style corresponding to the emotional state, and to provide the voice information to the terminal device in association with the response information.

What is claimed is:

1. A system comprising:
a communication interface coupled to a packet-switched network;
a storage device; and
circuitry configured to:
receive, from a terminal device via the communication interface, attribute information and feature information of a virtual character, convert the feature information into internal structured data, and generate one or more prompt sentences in natural language based on the structured data;
select, based on the structured data and style information, at least one generative model from among an image generative neural network model and a voice generative neural network model, normalize and preprocess each generated prompt sentence into a model-specific input format, and cause the selected generative model to generate at least one of a visual representation or a voice representation corresponding to the virtual character;
analyze character data and symbol data received from the terminal device in a chat format by using a natural language processing module and an emotion classification module, estimate an emotional state of a user, and construct a response prompt sentence that includes content adapted to the estimated emotional state, and cause a text generative neural network model to generate a message based on the response prompt sentence;
perform post-processing on image data output from the image generative neural network model, comprising adjusting at least one of image dimension, quality, and background parameters, encoding the adjusted image data into a predetermined media format, storing the adjusted image data in the storage device, and transmitting reference information of the stored image data to the terminal device via the communication interface; and
generate a voice generation prompt sentence comprising text information and speaker style information, cause the voice generative neural network model to generate voice data corresponding to the voice generation prompt sentence, encode the voice data into a predetermined audio format, and store the encoded voice data in the storage device.

2. The system according to claim 1, wherein the circuitry is further configured to:
parse the attribute information to extract visual attribute parameters comprising at least appearance descriptors, color parameters, and style tags; and
construct an image generation prompt sentence by serializing the visual attribute parameters into a natural language description conforming to an input specification of the image generative neural network model.

3. The system according to claim 2, wherein the circuitry is further configured to:
apply a quality assessment model to the image data output from the image generative neural network model to compute a quality score; and
when the quality score falls below a predetermined threshold, modify the image generation prompt sentence and cause the image generative neural network model to regenerate the image data.

4. The system according to claim 3, wherein the circuitry is further configured to:
maintain a plurality of style template records in the storage device, each style template record specifying a combination of visual attribute parameters; and
select a style template record based on the attribute information and merge the selected style template record with the visual attribute parameters prior to constructing the image generation prompt sentence.

5. The system according to claim 1, wherein the circuitry is further configured to:
receive a voice selection from the terminal device, the voice selection comprising at least a speaker identifier and a speaking style parameter; and
construct the voice generation prompt sentence by combining the text information to be synthesized with the speaker identifier and the speaking style parameter in a structured format.

6. The system according to claim 5, wherein the circuitry is further configured to:
apply a voice quality evaluation model to the generated voice data to compute an audio quality score; and
when the audio quality score falls below a predetermined threshold, adjust the speaking style parameter in the voice generation prompt sentence and cause the voice generative neural network model to regenerate the voice data.

7. The system according to claim 1, wherein the emotion classification module comprises a classification model trained to map feature vectors derived from the character data and the symbol data to emotional state categories, and wherein the symbol data comprises emoji identifiers that are converted to semantic feature vectors by an embedding layer prior to classification.

8. The system according to claim 7, wherein the circuitry is further configured to:
concatenate a text feature vector derived from the character data and a symbol feature vector derived from the symbol data into a combined feature vector; and
apply the classification model to the combined feature vector to produce the emotional state categories and associated confidence scores.

9. The system according to claim 8, wherein the circuitry is further configured to:
construct the response prompt sentence by combining a system instruction specifying a response tone parameter derived from the emotional state categories, a conversation history comprising a sliding window of recent exchanges, and the character data from the user; and
input the response prompt sentence to the text generative neural network model to generate the message.

10. The system according to claim 9, wherein the response tone parameter is determined by mapping the emotional state categories to a valence-arousal space and selecting a tone modifier corresponding to the region of the valence-arousal space in which the estimated emotional state falls.

11. The system according to claim 1, wherein the circuitry is further configured to:
maintain a dialogue history in the storage device comprising the prompt sentences, the response prompt sentences, and the generated messages for each exchange in a session; and
apply a context window to the dialogue history to construct a contextual prefix for subsequent response prompt sentences.

12. The system according to claim 11, wherein the circuitry is further configured to:
generate a compressed summary of exchanges outside the context window using the text generative neural network model, and prepend the compressed summary to the contextual prefix to preserve long-range conversational continuity.

13. The system according to claim 1, wherein the circuitry is further configured to:
train an autoencoder neural network on historical emotional state sequences associated with dialogue sessions to establish a baseline reconstruction error distribution; and
detect an anomaly in a current emotional state sequence when a reconstruction error exceeds a predetermined threshold, the detected anomaly triggering a modification of the response tone parameter to prioritize a stabilization response.

14. The system according to claim 1, wherein the circuitry is further configured to:
receive, from the terminal device via the communication interface, feedback data indicating a quality assessment of the generated message; and
store the feedback data in the storage device in association with the corresponding response prompt sentence and generated message.

15. The system according to claim 14, wherein the circuitry is further configured to:
aggregate the feedback data over a plurality of sessions to identify response prompt sentence patterns correlated with positive feedback; and
update a response template stored in the storage device to preferentially use the identified patterns in subsequent response prompt sentence construction.

16. The system according to claim 15, wherein the circuitry is further configured to:
compute an engagement metric representing a ratio of user-initiated exchanges to total exchanges, and adjust the response tone parameter to increase interactive prompting when the engagement metric falls below a threshold, thereby implementing a closed-loop behavioral feedback mechanism.

17. The system according to claim 1, wherein the circuitry is further configured to:
orchestrate the image generative neural network model, the voice generative neural network model, and the text generative neural network model through a unified model interface module that manages prompt routing, input format conversion, and output collection for each model, the unified model interface module maintaining a model registry in the storage device specifying model endpoints, input format specifications, and output format specifications.

18. A system comprising:
a communication interface coupled to a packet-switched network;
a storage device; and
circuitry configured to:
receive, from a terminal device via the communication interface, attribute information and feature information, convert the feature information into structured data, and generate an image generation prompt sentence based on visual attribute parameters extracted from the structured data, cause an image generative neural network model to generate image data, apply quality assessment and post-processing to the image data, and store the processed image data in the storage device;
generate a voice generation prompt sentence based on a speaker identifier, a speaking style parameter, and text information, cause a voice generative neural network model to generate voice data, encode the voice data into a predetermined audio format, and store the encoded voice data in the storage device;
analyze character data and symbol data received from the terminal device using a natural language processing module and an emotion classification module to estimate an emotional state, construct a response prompt sentence comprising a tone parameter derived from the emotional state and a conversation history, and cause a text generative neural network model to generate a message;
transmit the processed image data, the encoded voice data, and the generated message to the terminal device via the communication interface; and
receive feedback data from the terminal device, store the feedback data, and update response templates based on aggregated feedback patterns.

19. The system according to claim 18, wherein the circuitry is further configured to:
orchestrate the image generative neural network model, the voice generative neural network model, and the text generative neural network model through a unified model interface module that routes prompts, converts input formats, and collects outputs according to a model registry stored in the storage device.

20. A method comprising:
receiving, from a terminal device via a communication interface coupled to a packet-switched network, attribute information and feature information of a virtual character, converting the feature information into structured data, and generating prompt sentences based on the structured data;
selecting at least one generative model from among an image generative neural network model and a voice generative neural network model, preprocessing the prompt sentences into model-specific input formats, and causing the selected generative model to generate at least one of a visual representation or a voice representation;
analyzing character data and symbol data received from the terminal device using a natural language processing module and an emotion classification module, estimating an emotional state, constructing a response prompt sentence adapted to the emotional state, and causing a text generative neural network model to generate a message;
performing post-processing on generated image data and encoding generated voice data into predetermined formats and storing the data in a storage device; and
transmitting the generated visual representation, voice representation, and message to the terminal device via the communication interface.
